(19) United States
(12) Patent Application Publication
(10) Pub. No.: US 2026/0295844 A1
(43) Pub. Date: Oct. 1, 2026

(54) Control Method And Non-Transitory Computer-Readable Storage Medium Storing Program

(71) Applicant: SEIKO EPSON CORPORATION, Tokyo (JP)

(72) Inventors: Masamichi SUZUKI, Masamuto (JP); Yoshinori NAKAJIMA, Matsumoto (JP); Masaru KUMAGAI, Shiojiri (JP)

(21) Appl. No.: 19/629,307

(22) Filed: Mar. 26, 2026

(30) Foreign Application Priority Data
Mar. 27, 2025 (JP) 2025-053323

(51) Int. Cl. B25J 9/16

(52) U.S. Cl. CPC B25J 9/1692; B25J 9/1638

(57) ABSTRACT

Provided is a control method for operating a robot that supports an object and includes a plurality of joints, the method including moving the object to a first teaching point such that the object passes through a first point, and moving the object to a second teaching point such that the object passes through the first point.

The present application is based on, and claims priority from JP Application Serial Number 2025-053323, filed Mar. 27, 2025, the disclosure of which is hereby incorporated by reference herein in its entirety.

### BACKGROUND

### 1. Technical Field

The present disclosure relates to a control method and a non-transitory computer-readable storage medium storing a program.

### 2. Related Art

In the related art, a three-dimensional object printing apparatus that performs printing on a surface of a three-dimensional workpiece by an ink jet method is known. For example, JP-A-2022-127793 discloses a control method of controlling a three-dimensional object printing apparatus including a robot that supports an object to be supported such as a workpiece and includes a plurality of joints, and a head scanning mechanism including a head that ejects a liquid such as ink to the object to be supported.

However, even when the object to be supported is moved to a teaching point with respect to the robot including the plurality of joints supporting the object to be supported, the object to be supported may be deviated from the teaching point.

### SUMMARY

According to a preferred aspect of the present disclosure, there is provided a control method for operating a robot that supports an object and includes a plurality of joints, the method including: moving the object to a first teaching point after the object passes through a first point when moving the object to the first teaching point; and moving the object to a second teaching point after the object passes through the first point when moving the object to the second teaching point.

According to another preferred aspect of the present disclosure, there is provided a non-transitory computer-readable storage medium storing a program for causing a robot that supports an object to execute: a process in which the object is moved to a first teaching point after the object passes through a second point and a first point in this order when moving the object to the first teaching point; and a process in which the object is moved to a second teaching point after the object passes through the second point and the first point in this order when moving the object to the second teaching point.

### BRIEF DESCRIPTION OF THE DRAWINGS

FIG. 1 is a perspective view illustrating an outline of a three-dimensional object printing apparatus according to a first embodiment.

FIG. 2 is a view illustrating a parallel link mechanism.

FIG. 3 is a block diagram illustrating an electrical configuration of the three-dimensional object printing apparatus according to the first embodiment.

FIG. 4 is a perspective view illustrating a schematic configuration of a liquid ejection unit according to the first embodiment.

FIG. 5 is a flowchart illustrating a flow of a three-dimensional object printing method according to the first embodiment.

FIG. 6 is a view illustrating a print region according to the first embodiment.

FIG. 7 is a view illustrating a workpiece movement operation in step S140.

FIG. 8 is a view illustrating a workpiece movement operation in step S160.

FIG. 9 is a view illustrating an example of a configuration of a measurement system that executes a generation process.

FIG. 10 is a view illustrating a state in which a marker is attached to the workpiece movement mechanism.

FIG. 11 is a view illustrating a state in which a marker is attached to the workpiece movement mechanism.

FIG. 12 is a flowchart illustrating an example of a generation process.

FIG. 13 is a view illustrating a plurality of measurement trajectories viewed in a Z2 direction.

FIG. 14 is a view illustrating a plurality of measurement trajectories viewed in a Y1 direction.

FIG. 15 is a table illustrating an example of a content of a correction calculation table.

FIG. 16 is a block diagram illustrating an electrical configuration of a three-dimensional object printing apparatus according to a first modification example.

FIG. 17 is a flowchart illustrating a flow of a three-dimensional object printing method according to the first modification example.

FIG. 18 is a flowchart illustrating a correction process.

FIG. 19 is a view illustrating a process of step S340 and a process of step S350.

FIG. 20 is a flowchart illustrating a correction process in a second modification example.

FIG. 21 is a flowchart illustrating a correction process in a fourth modification example.

FIG. 22 is a view illustrating a workpiece movement operation in a fourth modification example.

### DESCRIPTION OF EMBODIMENTS

Hereinafter, preferred embodiments according to the present disclosure will be described with reference to the accompanying drawings. Note that in the drawings, dimensions or scales of each portion are different from the actual dimensions or scales as appropriate, and some units are schematically illustrated for easy understanding. In addition, the scope of the present disclosure is not limited to these embodiments unless it is noted in the following description that the present disclosure is particularly limited.

The following description will be made by using, as appropriate, an X-axis, a Y-axis, and a Z-axis that intersect each other. In addition, one direction along the X-axis is referred to as an X1 direction, and a direction opposite to the X1 direction is referred to as an X2 direction. Similarly, opposite directions that extend along the Y-axis will be referred to as a Y1 direction and a Y2 direction. In addition, opposite directions that extend along the Z-axis will be referred to as a Z1 direction and a Z2 direction.

Here, the X-axis, the Y-axis, and the Z-axis are coordinate axes of a base coordinate system set in a space in which a workpiece W and a base portion 210 to be described later are installed. Typically, the Z-axis is a vertical axis, and the Z2 direction corresponds to a downward direction in a vertical direction. Note that the Z-axis may not be the vertical axis. Although the X-axis, the Y-axis, and the Z-axis are typically orthogonal to each other, the present disclosure is not limited thereto, and the axes may not be orthogonal to each other. For example, the X-axis, Y-axis, and Z-axis may intersect with each other at an angle within a range of 80° or more and 100° or less.

### 1. First Embodiment

### 1-1. Outline of Three-Dimensional Object Printing Apparatus

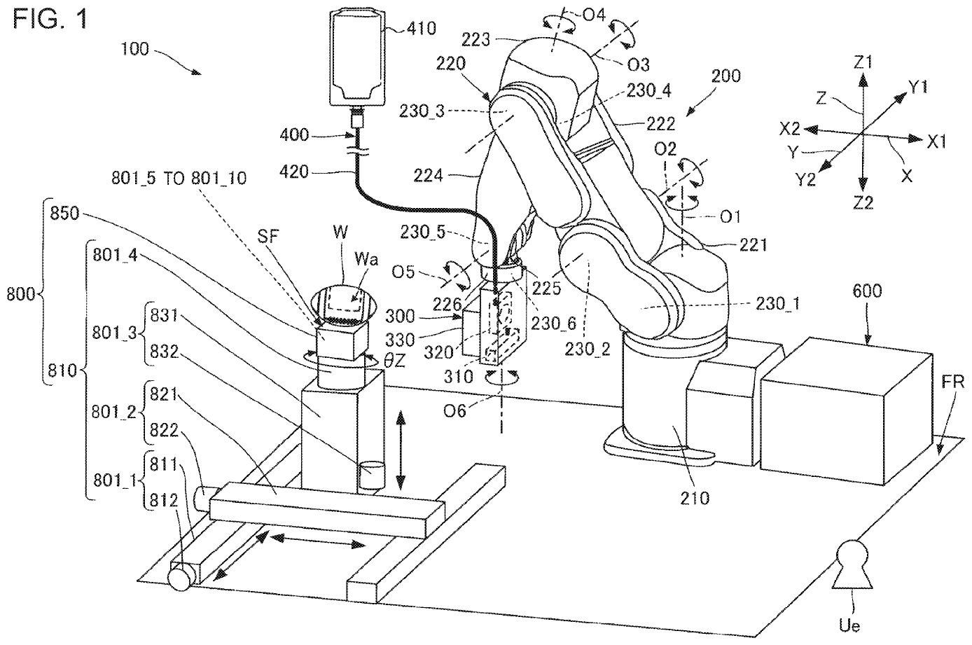

FIG. 1 is a perspective view illustrating an outline of a three-dimensional object printing apparatus 100 according to a first embodiment. The three-dimensional object printing apparatus 100 is an apparatus that performs printing on a part or the entire surface of a three-dimensional workpiece W by an ink jet method. In the first embodiment, the three-dimensional object printing apparatus 100 is used by a user Ue of the three-dimensional object printing apparatus 100. The user Ue is, for example, a manufacturer who performs printing on the workpiece W. The three-dimensional object printing apparatus 100 is provided to the user Ue by a robot manufacturer who is a developer of the three-dimensional object printing apparatus 100.

The workpiece W has a surface including a print region Wa, which is a range in which an image is formed. In the example illustrated in FIG. 1, the workpiece W is a rugby ball having a spheroidal shape, and the print region Wa is a curved surface having a non-constant curvature. Note that the workpiece W is not limited to the rugby ball and may be any workpiece.

In the example illustrated in FIG. 1, the three-dimensional object printing apparatus 100 is an ink jet printer using a vertical articulated robot. Specifically, as illustrated in FIG. 1, the three-dimensional object printing apparatus 100 includes a head scanning mechanism 200, a liquid ejection unit 300, a liquid supply unit 400, a controller 600, and a workpiece movement mechanism 800. Note that the workpiece movement mechanism 800 is an example of a “robot”. The workpiece W is an example of an “object to be supported”.

Hereinafter, first, each portion of the three-dimensional object printing apparatus 100 illustrated in FIG. 1 will be briefly described in sequence. The head scanning mechanism 200 is a movement mechanism that changes a position and a posture of the liquid ejection unit 300 relative to the workpiece W. In the example illustrated in FIG. 1, the head scanning mechanism 200 is a so-called 6-axis vertical articulated robot. Specifically, the head scanning mechanism 200 includes a base portion 210 and an arm 220.

The base portion 210 is a base that supports the arm 220. In the example illustrated in FIG. 1, the base portion 210 is fixed to an installation surface FR such as a floor surface facing the Z1 direction by screwing or the like.

The arm 220 is a 6-axis robot arm having a base end portion attached to the base portion 210 and a tip end portion of which a position and a posture are three-dimensionally changed with respect to the base end portion.

Specifically, the arm 220 includes arm components 221, 222, 223, 224, 225, and 226, which are coupled in this order. Furthermore, the arm 220 is articulated, that is, the arm 220 includes a plurality of joints 230.

The arm components 221 to 226 are coupled via joints 230_1 to 230_6 and are rotatable around rotation axes O1 to O6. Note that hereinafter, each of the joints 230_1 to 230_6 may be referred to as a joint 230.

Each of the joints 230_1 to 230_6 is a rotary joint that is rotatable around the rotation axis. The head scanning mechanism 200 in the present embodiment includes only rotary joints, but may have one or a plurality of linear motion joints. When one arm component and the other arm component are coupled via a linear motion joint, the one arm component moves along one axis with respect to the other arm component via the linear motion joint.

The arm component 222 and the arm component 223 are members extending in a direction perpendicular to the rotation axis O3. An extending direction of the arm component 222 changes depending on one or both of rotation angles of the joint 230_1 and the joint 230_2. An extending direction of the arm component 223 changes depending on one or a plurality of rotation angles of the joint 230_1, the joint 230_2, and the joint 230_3.

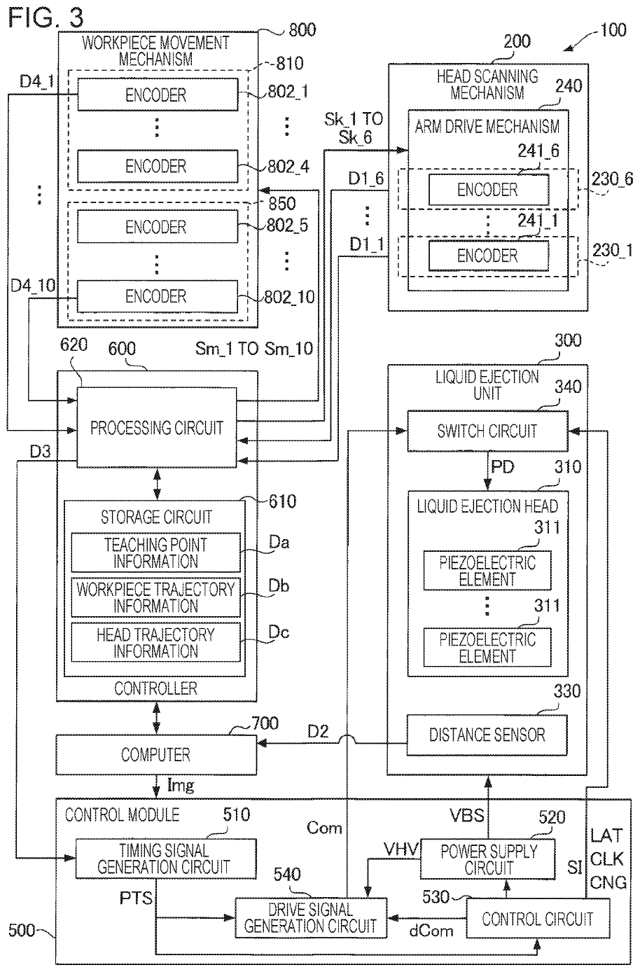

Each of the joints 230_1 to 230_6 is a mechanism that rotatably couples one of two adjacent arm components to the other arm component. Although not illustrated in FIG. 1, a drive mechanism for rotating one of two adjacent arm components relative to the other arm component is provided in each of the joints 230_1 to 230_6. The drive mechanism includes, for example, a motor that generates a driving force for rotation, a speed reducer that decelerates and outputs the driving force, an encoder such as a rotary encoder that detects an operation amount such as an angle of the rotation, and the like. Note that an assembly of the drive mechanisms corresponds to an arm drive mechanism 240 illustrated in FIG. 3 to be described later. The encoder corresponds to an encoder 241 illustrated in FIG. 3 and the like to be described later.

The rotation axis O1 is an axis perpendicular to the installation surface FR to which the base portion 210 is fixed. The rotation axis O2 is an axis perpendicular to the rotation axis O1. The rotation axis O3 is an axis parallel to the rotation axis O2. The rotation axis O4 is an axis perpendicular to the rotation axis O3. The rotation axis O5 is an axis perpendicular to the rotation axis O4. The rotation axis O6 is an axis perpendicular to the rotation axis O5.

Note that in the rotation axes, the term “perpendicular” includes not only a case where an angle made by two rotation axes is strictly 90 degrees, but also a case where the angle formed by the two rotation axes deviates from 90 degrees within a range of approximately +5 degrees. Similarly, the term “parallel” includes not only a case where two rotation axes are strictly parallel, but also a case where one of the two rotation axes tilts with respect to the other axis within a range of approximately +5 degrees.

The liquid ejection unit 300 is attached, as an end effector, to a tip end portion of the arm 220, that is, the arm component 226 in a state of being fixed by screwing or the like.

The liquid ejection unit 300 is a device including a head 310 that ejects ink which is an example of a liquid toward the workpiece W. In the present embodiment, the liquid ejection unit 300 includes a pressure adjustment valve 320 that adjusts a pressure of the ink to be supplied to the head 310, and a distance sensor 330 that measures a distance from the workpiece W in addition to the head 310.

The ink is not particularly limited, and examples thereof include an aqueous ink in which a coloring material such as a dye or a pigment is dissolved in an aqueous solvent, a curable ink using a curable resin such as an ultraviolet curable type resin, a solvent-based ink in which a coloring material such as a dye or a pigment is dissolved in an organic solvent, and the like.

Although not illustrated, the head 310 includes a piezoelectric element 311, a cavity for accommodating the ink, and a nozzle N communicatively coupled to the cavity.

The pressure adjustment valve 320 is a valve mechanism that opens and closes according to a pressure of the ink in the head 310.

The distance sensor 330 is an optical displacement sensor that measures a distance between the head 310 and the workpiece W. Note that the distance sensor 330 may be provided as necessary, or may be omitted. In addition, in the example illustrated in FIG. 1, the number of each of the head 310 and the pressure adjustment valve 320 included in the liquid ejection unit 300 is one, but the number is not limited to the example illustrated in FIG. 1, and may be two or more.

The liquid supply unit 400 is a mechanism for supplying the ink to the head 310. The liquid supply unit 400 includes a liquid storage portion 410 and a supply flow path 420.

The liquid storage portion 410 is a container that stores the ink. The liquid storage portion 410 is, for example, a bag-shaped ink pack made of a flexible film.

In the example illustrated in FIG. 1, the liquid storage portion 410 is fixed to a wall, a ceiling, a pillar, or the like to be positioned always in the Z1 direction with respect to the head 310.

Note that an installation location of the liquid storage portion 410 may be any location as long as the ink can be supplied from the liquid storage portion 410 to the head 310 at a predetermined pressure, and may be positioned below the head 310 in the vertical direction.

The supply flow path 420 is a flow path for supplying the ink from the liquid storage portion 410 to the head 310. The pressure adjustment valve 320 is provided in the middle of the supply flow path 420.

The supply flow path 420 is formed with, for example, an internal space of a pipe body.

The controller 600 is a robot controller that controls the drive of the head scanning mechanism 200. Although not illustrated in FIG. 1, a control module that controls an ejection operation of the liquid ejection unit 300 is electrically coupled to the controller 600. A computer is communicably connected to the controller 600 and the control module. Note that the control module corresponds to a control module 500 illustrated in FIG. 3 to be described later. The computer corresponds to a computer 700 illustrated in FIG. 3 to be described later.

The workpiece movement mechanism 800 is a robot that supports the workpiece W and is articulated, that is, the workpiece movement mechanism 800 includes a plurality of joints 801. The workpiece movement mechanism 800 includes an XYZθ movement mechanism 810 and a parallel link mechanism 850. Note that in FIG. 1, to prevent the drawing from being complicated, a shape of the parallel link mechanism 850 is shown in a simplified manner.

The XYZθ movement mechanism 810 is a mechanism that can move the workpiece W in a direction along each of the X-axis, the Y-axis, and the Z-axis, and can further rotate the workpiece W around a rotation axis OZ parallel to the Z-axis. The XYZθ movement mechanism 810 includes a Y-axis linear motion joint 801_1, an X-axis linear motion joint 801_2, a Z-axis linear motion joint 801_3, and a Z-axis rotary joint 801_4. Further, the workpiece movement mechanism 800 includes the parallel link mechanism 850 including a part of the plurality of joints 801.

The Y-axis linear motion joint 801_1 is a mechanism for moving the X-axis linear motion joint 801_2 in a direction along the Y-axis. The Y-axis linear motion joint 801_1 includes, for example, a rail member 811 extending along the Y-axis and a drive mechanism 812 that moves the X-axis linear motion joint 801_2. The drive mechanism includes, for example, a motor that generates a driving force for the movement, a speed reducer that decelerates and outputs the driving force, and an encoder 802_1 that detects the operation amount of the movement. The encoder 802_1 is illustrated in FIG. 3.

The X-axis linear motion joint 801_2 is a mechanism for moving the Z-axis linear motion joint 801_3 in a direction along the X-axis. The X-axis linear motion joint 801_2 includes, for example, a rail member 821 extending along the X-axis and a drive mechanism 822 that moves the Z-axis linear motion joint 801_3. The drive mechanism includes, for example, a motor that generates a driving force for the movement, a speed reducer that decelerates and outputs the driving force, and an encoder 802_2 that detects an operation amount of the movement. The encoder 802_2 is illustrated in FIG. 3.

The Z-axis linear motion joint 801_3 is a mechanism that moves the Z-axis rotary joint 801_4 in a direction along the Z-axis. The Z-axis linear motion joint 801_3 includes, for example, a rail member 831 extending along the Z-axis and a drive mechanism 832 that moves the Z-axis linear motion joint 801_3. The drive mechanism includes, for example, a motor that generates a driving force for the movement, a speed reducer that decelerates and outputs the driving force, and an encoder 802_3 that detects an operation amount of the movement. The encoder 802_3 is illustrated in FIG. 3.

The Z-axis rotary joint 801_4 rotates the parallel link mechanism 850 around the rotation axis OZ parallel to the Z-axis. The Z-axis rotary joint 801_4 includes a motor that generates a driving force for rotating the Z-axis rotary joint 801_4 with respect to the Z-axis linear motion joint 801_3, a speed reducer that decelerates and outputs the driving force, and an encoder 802_4 that detects an operation amount such as an angle of the rotation. The encoder 802_4 is illustrated in FIG. 3.

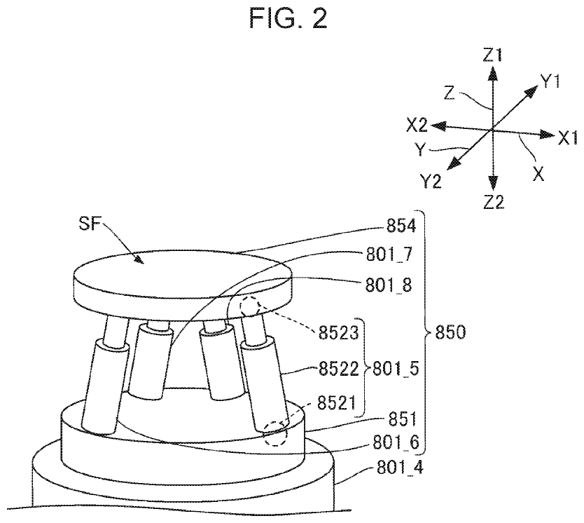

The parallel link mechanism 850 has a mounting surface SF on which the workpiece W is mounted, and a direction in which the mounting surface SF faces can be changed by moving a plurality of joints 801_5 to 801_10 included in the parallel link mechanism 850 in parallel. The parallel link mechanism 850 will be described with reference to FIG. 2.

FIG. 2 is a view illustrating the parallel link mechanism 850. The parallel link mechanism 850 illustrated in FIG. 2 includes a base member 851, six in-link linear motion joints 801_5 to 801_10, and an output link member 854. The base member 851 and the output link member 854 are flat members. The base member 851 is fixed to the Z-axis rotary joint 801_4. A surface of the output link member 854 facing the Z1 direction is the mounting surface SF. However, in order to prevent the drawing from being complicated, display of the in-link linear motion joint 801_9 and 801_10 is omitted in FIG. 2.

The six in-link linear motion joints 801_5 to 801_10 are mechanisms in which a length in an extending direction can be changed. Hereinafter, in a case of not being distinguished, the six in-link linear motion joints 801_5 to 801_10 may be collectively referred to as in-link linear motion joints 801L. The six in-link linear motion joints 801L are provided between the base member 851 and the output link member 854. Note that the number of the in-link linear motion joints 801L included in the parallel link mechanism 850 is not limited to six, and may be three or more.

Each of the six in-link linear motion joints 801L includes a lower joint portion 8521, a linear motion mechanism 8522, and an upper joint portion 8523. The lower joint portion 8521 is a spherical joint that couples the base member 851 and the linear motion mechanism 8522. An extending direction of the linear motion mechanism 8522 with respect to the base member 851 is changed by the lower joint portion 8521. The upper joint portion 8523 is a spherical joint that couples the linear motion mechanism 8522 and the output link member 854. The extending direction of the linear motion mechanism 8522 with respect to the output link member 854 is changed by the upper joint portion 8523.

The linear motion mechanism 8522 can change the length in the extending direction. The linear motion mechanism 8522 included in each of the six in-link linear motion joints 801L includes, for example, a hollow shaft, a cylindrical member inserted into the shaft and moving in an extending direction of the shaft, a motor that generates a driving force for moving the cylindrical member, a speed reducer that decelerates and outputs the driving force, and an encoder 802 that detects an operation amount of the movement. The in-link linear motion joints 801_5 to 801_10 include the encoders 802_5 to 802_10, respectively. The encoders 802_5 to 802_10 are illustrated in FIG. 3.

The direction in which the mounting surface SF faces is changed by changing a length of the six in-link linear motion joints 801L. For example, when one of the six in-link linear motion joints 801L becomes shorter, the output link member 854 is inclined via the upper joint portion 8523 in the in-link linear motion joints 801L.

Note that the parallel link mechanism 850 includes the six in-link linear motion joints 801L, but may include two or more rotary joints instead of the six in-link linear motion joints 801L.

The description will return to FIG. 1. As described above, the workpiece movement mechanism 800 includes the Y-axis linear motion joint 801_1, the X-axis linear motion joint 801_2, the Z-axis linear motion joint 801_3, the Z-axis rotary joint 801_4, and the six in-link linear motion joints 801L as the plurality of joints 801. Hereinafter, as a plurality of joints 801, the Y-axis linear motion joint 801_1, the X-axis linear motion joint 801_2, the Z-axis linear motion joint 801_3, the Z-axis rotary joint 801_4, and the six in-link linear motion joints 801L may be referred to as joints 801. Hereinafter, the number of the joints 801 included in the workpiece movement mechanism 800 is set to L. In the first embodiment, L is 10. However, the workpiece movement mechanism 800 may include two or more joints 801, and may not include, for example, the parallel link mechanism 850. Note that it is preferable that the workpiece movement mechanism 800 includes six or more degrees of freedom to arbitrarily change a posture of the workpiece W.

### 1-2. Electrical Configuration of Three-Dimensional Object Printing Apparatus 100

FIG. 3 is a block diagram illustrating an electrical configuration of the three-dimensional object printing apparatus 100 according to the first embodiment. In FIG. 3, among components of the three-dimensional object printing apparatus 100, electrical components are illustrated. FIG. 3 illustrates the arm drive mechanism 240 including the encoder 241_1 to the encoder 241_6. The arm drive mechanism 240 is an assembly of the above-described drive mechanisms that operate the joint 230_1 to the joint 230_6. The encoder 241_1 to the encoder 241_6 are provided in correspondence with the joint 230_1 to the joint 230_6, and measure operation amounts such as rotation angles of the encoder 241_1 to the encoder 241_6. Note that hereinafter, each of the encoders 241_1 to 241_6 may be referred to as an encoder 241.

Further, FIG. 3 illustrates the encoders 802_1 to 802_10. The encoders 802_1 to 802_10 are provided in correspondence with the joints 801_1 to 801_10, and measure an operation amount such as a movement amount or a rotation angle of the encoders 802_1 to 802_10. Note that in the following description, the encoders 802_1 to 802_10 may be referred to as an encoder 802.

As illustrated in FIG. 3, the three-dimensional object printing apparatus 100 includes the control module 500 and the computer 700 in addition to the head scanning mechanism 200, the liquid ejection unit 300, the controller 600, and the workpiece movement mechanism 800 described above. Note that each of the electrical components to be described below may be divided appropriately, a part thereof may be included in another component, or may be integrally formed with another component. For example, a part or all of functions of the control module 500 or the controller 600 may be realized by the computer 700 connected to the controller 600, or may be realized by another external device such as a personal computer (PC) connected to the controller 600 via a network such as a local area network (LAN) or the Internet.

The controller 600 has a function of controlling the drive of the head scanning mechanism 200, a function of controlling the operation of the workpiece movement mechanism 800, and a function of generating a signal D3 for synchronizing the ejection operation of the head 310 with the operation of the head scanning mechanism 200. The controller 600 includes a storage circuit 610 and a processing circuit 620.

The storage circuit 610 stores various programs executed by the processing circuit 620 and various kinds of data processed by the processing circuit 620. The storage circuit 610 includes, for example, a semiconductor memory of one or both of a volatile memory such as a random-access memory (RAM) and a non-volatile memory such as a read only memory (ROM), an electrically erasable programmable read-only memory (EEPROM) or a programmable ROM (PROM). Note that a part or all of the storage circuit 610 may be included in the processing circuit 620.

The storage circuit 610 stores teaching point information Da, workpiece trajectory information Db, and head trajectory information Dc. The teaching point information Da is information on a position of the workpiece W. Specifically, the teaching point information Da is information on a plurality of teaching points TP to be described later.

The workpiece trajectory information Db is information indicating a movement path along which the workpiece W is to move. Specifically, the workpiece trajectory information Db includes information indicating a trajectory described later in which the plurality of teaching points TP are used as a start position and an end position. The above-described workpiece trajectory information Db is input from the computer 700 to the storage circuit 610.

The head trajectory information Dc is information indicating a movement path along which the head 310 is to move. The head trajectory information Dc includes information indicating a movement path along which a tool center point indicating the origin of a tool coordinate system is to move. The head trajectory information Dc is determined based on workpiece information indicating a shape of the workpiece W and the workpiece trajectory information Db. The workpiece information is obtained by associating information such as computer-aided design (CAD) data indicating a three-dimensional shape of the workpiece W with the above-described base coordinate system. The head trajectory information Dc is input from the computer 700 to the storage circuit 610.

The processing circuit 620 controls the operation of each of the joints 801_1 to 801_10 based on the workpiece trajectory information Db. Specifically, the processing circuit 620 performs an inverse kinematic calculation, which is a calculation for converting the workpiece trajectory information Db into an operation amount such as a movement amount, a rotation angle, and a rotation speed of each of the joints 801_1 to 801_10. The processing circuit 620 outputs control signals Sm_1 to Sm_10 based on outputs D4_1 to D4_10 from the encoders 802_1 to 802_10 included in the workpiece movement mechanism 800 such that an actual operation amount such as an actual rotation angle and an actual rotation speed of each of the joints 801_1 to 801_10 becomes the above-described calculation result. The control signals Sm_1 to Sm_10 correspond to the joints 801_1 to 801_10 and control the drive of a motor provided in a corresponding joint 801. Note that the outputs D4_1 to D4_10 correspond to the encoders 802_1 to 802_10. In the following, each of the outputs D4_1 to D4_10 may be referred to as an output D4.

Further, the processing circuit 620 controls the operation of each of the joints 230_1 to 230_6 based on the head trajectory information Dc, and generates a signal D3. Specifically, the processing circuit 620 performs an inverse kinematic calculation, which is a calculation for converting the head trajectory information Dc into an operation amount such as a rotation angle and a rotation speed of each joint 230_1 to the joint 230_6. The processing circuit 620 outputs a control signal Sk_1 to a control signal Sk_6 based on an output signal D1_1 to an output signal D1_6 of the encoder 241_1 to the encoder 241_6 included in the arm drive mechanism 240 of the head scanning mechanism 200 such that an operation amount such as an actual rotation angle and an actual rotation speed of each of the joints 230_1 to 230_6 becomes the above-described calculation result. Each of the control signal Sk_1 to the control signal Sk_6 corresponds to each of the joints 230_1 to 230_6, and controls the drive of a motor provided in a corresponding joint 230. Note that each of the output signals D1_1 to D1_6 corresponds to each of the encoders 241_1 to 241_6. Hereinafter, each of the output signals D1_1 to D1_6 may be referred to as an output signal D1.

The processing circuit 620 generates a signal D3 based on the output signal D1 from at least one of the encoder 241_1 to the encoder 241_6.

The processing circuit 620 described above includes, for example, one or more processors such as a central processing unit (CPU). Note that the processing circuit 620 may include a programmable logic device such as a field-programmable gate array (FPGA) instead of the CPU or in addition to the CPU.

The control module 500 is a circuit that controls an ejection operation of the head 310 based on the signal D3 output from the controller 600 and print data Img from the computer 700. The control module 500 includes a timing signal generation circuit 510, a power supply circuit 520, a control circuit 530, and a drive signal generation circuit 540.

The timing signal generation circuit 510 generates a timing signal PTS based on the signal D3.

The power supply circuit 520 is supplied with electric power from a commercial power supply (not illustrated) and generates various predetermined potentials. The generated various potentials are appropriately supplied to each portion of the three-dimensional object printing apparatus 100. For example, the power supply circuit 520 generates a power supply potential VHV and an offset potential VBS. The offset potential VBS is supplied to the liquid ejection unit 300. The power supply potential VHV is supplied to the drive signal generation circuit 540.

The control circuit 530 generates a control signal SI, a waveform designation signal dCom, a latch signal LAT, a clock signal CLK, and a change signal CNG based on the timing signal PTS. These signals are synchronized with the timing signal PTS. Among these signals, the waveform designation signal dCom is input to the drive signal generation circuit 540, and the other signals are input to a switch circuit 340 of the liquid ejection unit 300.

The control signal SI is a digital signal for designating an operation state of a piezoelectric element 311 included in the head 310. The waveform designation signal dCom is a digital signal for defining a waveform of the drive signal Com. The latch signal LAT and the change signal CNG are used in combination with the control signal SI, and define a drive timing of the piezoelectric element 311 to define an ejection timing of the ink from the nozzle N. The clock signal CLK is a reference clock signal synchronized with the timing signal PTS.

For example, the above-described control circuit 530 includes one or more processors such as a central processing unit (CPU). Note that the control circuit 530 may include a programmable logic device such as a field-programmable gate array (FPGA) instead of the CPU or in addition to the CPU.

The drive signal generation circuit 540 is a circuit that generates a drive signal Com for driving each piezoelectric element 311 included in the head 310. Here, among waveforms included in the drive signal Com, a signal of a waveform actually supplied to the piezoelectric element 311 is a drive pulse PD. The drive pulse PD is supplied from the drive signal generation circuit 540 to the piezoelectric element 311 via the switch circuit 340. The switch circuit 340 switches whether to supply, as the drive pulse PD, at least a part of waveforms included in the drive signal Com based on the control signal SI.

The computer 700 has a function of supplying information such as the teaching point information Da, the workpiece trajectory information Db, and the head trajectory information Dc to the controller 600, and a function of supplying information such as the print data Img to the control module 500. For example, the computer 700 generates the workpiece trajectory information Db based on the workpiece information indicating the shape of the workpiece W and the teaching point information Da. Further, the computer 700 generates the head trajectory information Dc based on the workpiece information and the workpiece trajectory information Db. The computer 700 transmits the teaching point information Da, the workpiece trajectory information Db, and the head trajectory information Dc to the controller 600. Further, the computer 700 of the present embodiment is electrically coupled to the above-described distance sensor 330, and supplies information for correcting the head trajectory information Dc to the controller 600 based on a signal D2 from the distance sensor 330. The computer 700 includes a processing circuit including a CPU and a recording circuit (not illustrated). The computer 700 is, for example, a PC. Note that the computer 700 functions as a control portion of the three-dimensional object printing apparatus 100, and causes the head scanning mechanism 200 and the liquid ejection unit 300 to execute a print operation A, a print operation B, and a print operation C to be described later via the controller 600 and the control module 500.

### 1-3. Liquid Ejection Unit 300

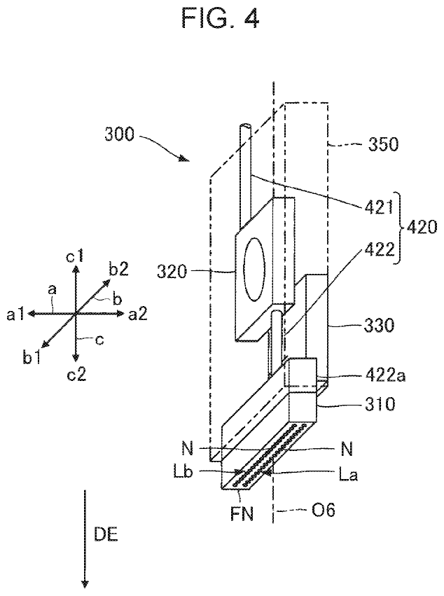

FIG. 4 is a perspective view illustrating a schematic configuration of the liquid ejection unit 300 according to the first embodiment.

The following description will be made by using an a-axis, a b-axis, and a c-axis that intersect each other as appropriate. One direction along the a-axis is referred to as an a1 direction, and a direction opposite to the a1 direction is referred to as an a2 direction. Similarly, directions opposite to each other along the b-axis are referred to as a b1 direction and a b2 direction. Further, directions opposite to each other along the c-axis are referred to as a c1 direction and a c2 direction.

Here, the a-axis, the b-axis, and the c-axis are coordinate axes of a tool coordinate system set in the liquid ejection unit 300, and the relative positional and postural relationship with the X-axis, the Y-axis, and the Z-axis described above changes by the operation of the head scanning mechanism 200 described above. In the example illustrated in FIG. 4, the c-axis is parallel to the above-described rotation axis O6. Note that although the a-axis, the b-axis, and the c-axis are typically orthogonal to each other, the present disclosure is not limited thereto, and the axes may intersect at an angle within, for example, a range of 80 degrees or more and 100 degrees or less.

As described above, the liquid ejection unit 300 includes the head 310, the pressure adjustment valve 320, and the distance sensor 330. These portions are supported by a support 350 illustrated by a two-dot chain line in FIG. 4.

The support 350 is made of, for example, a metal material or the like, and is a substantially rigid body. Note that in FIG. 4, the support 350 has a flat box shape, but the shape of the support 350 is not particularly limited and is any shape.

The above support 350 is attached to the tip end of the arm 220, that is, the arm component 226.

In the example illustrated in FIG. 4, the pressure adjustment valve 320 is positioned in the c1 direction with respect to the head 310. The distance sensor 330 is positioned in the a2 direction with respect to the head 310.

The supply flow path 420 is divided into an upstream flow path 421 and a downstream flow path 422 by the pressure adjustment valve 320. That is, the supply flow path 420 includes the upstream flow path 421 that communicatively couples the liquid storage portion 410 and the pressure adjustment valve 320, and the downstream flow path 422 that communicatively couples the pressure adjustment valve 320 and the head 310. In the example illustrated in FIG. 4, a part of the downstream flow path 422 of the supply flow path 420 is formed by a flow path member 422a. The flow path member 422a has a flow path for distributing ink from the pressure adjustment valve 320 to a plurality of locations of the head 310.

The head 310 has a nozzle surface FN and the plurality of nozzles N that are opened to the nozzle surface FN. In the example illustrated in FIG. 4, a normal direction of the nozzle surface FN is the c2 direction, and the plurality of nozzles N are divided into a first nozzle row La and a second nozzle row Lb arranged at intervals in a direction along the a-axis. Hereinafter, the first nozzle row La and the second nozzle row Lb may be referred to as a nozzle row Ln without distinction. Each of the first nozzle row La and the second nozzle row Lb is a set of the plurality of nozzles N linearly arranged in a direction along the b-axis.

### 1-4. Regarding Positioning Accuracy of Workpiece W

Regarding positioning accuracy of the workpiece W, since accuracy of a position of the workpiece W affects printing quality, it is required to control the position of the workpiece W and the operation of the workpiece movement mechanism 800 with high accuracy. When the positioning accuracy of the workpiece W is low, the workpiece W may be deviated from the teaching point even when the user Ue tries to move the workpiece W to the teaching point designated in advance. Hereinafter, the teaching point may be referred to as a teaching point TP. An example in which the positioning accuracy of the workpiece W affects the printing quality is stitch printing. When printing is performed over a wide range of the workpiece W by the stitch printing, when the positioning accuracy of the workpiece W is low, printing may not be performed as desired by the user Ue. Specifically, in the stitch printing, when the positioning accuracy of the workpiece W is low, printing unevenness or a white stripe may occur. The white stripe is a minute gap to which the ink does not adhere.

The present inventors found that the positioning accuracy of the workpiece W by the workpiece movement mechanism 800 is different for each trajectory passing through the teaching point TP. That is, it was found that the positional deviation occurs at the teaching point TP depending on the trajectory through which the workpiece movement mechanism 800 passes, even when teaching points TP input to the workpiece movement mechanism 800 are the same. Further, the inventors estimated that the reason for the positional deviation depending on the trajectory through which the workpiece movement mechanism 800 passes is backlash provided in the workpiece movement mechanism 800. The backlash is a gap provided between gears or belts of machines. The present inventors estimated that the positional deviation occurs when a state of backlash at a point of time when the teaching point TP is reached via a certain trajectory is different from a state of backlash at a point of time when the teaching point TP is reached via a trajectory different from the certain trajectory. For example, when there are two meshing gears, the state of backlash means whether a gap between the two gears is in a forward side or backward side in a rotation direction with respect to one gear. Hereinafter, the amount of the gap on the forward side of one of the two meshing gears in the rotation direction may be referred to as the amount of backlash. For example, when there is a maximum gap on the forward side in the rotation direction with respect to one gear, the amount of backlash is maximum, and when there is no gap on the forward side in the rotation direction with respect to one gear and there is a maximum gap on the backward side in the rotation direction, the amount of backlash is 0.

Therefore, in the first embodiment, a path immediately before reaching the teaching point TP is made common to reduce the positional deviation of the workpiece W at the teaching point TP. Specifically, the workpiece movement mechanism 800 is controlled to move the workpiece W to the teaching point TP after the workpiece W passes through a position AP and a home position HP in this order. The position AP is an example of a “second point”. The home position HP is an example of a “first point”.

### 1-5. Operation of Three-Dimensional Object Printing Apparatus 100 and Three-Dimensional Object Printing Method

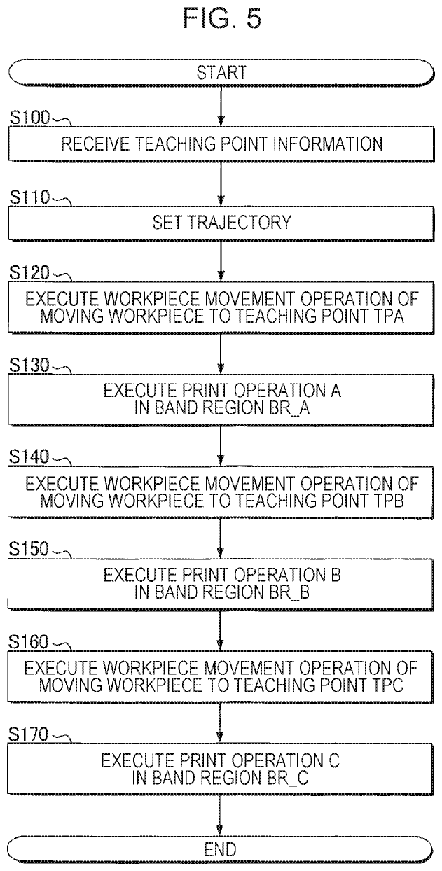

FIG. 5 is a flowchart illustrating a flow of a three-dimensional object printing method according to the first embodiment. The three-dimensional object printing method is performed by using the above-described three-dimensional object printing apparatus 100. As illustrated in FIG. 5, the three-dimensional object printing apparatus 100 executes step S100 of receiving the teaching point information Da, step S110 of setting a trajectory, step S120 of moving the workpiece W to a teaching point TPA, step S130 of executing a print operation A in a band region BR_A, step S140 of executing the workpiece movement operation of moving the workpiece W to a teaching point TPB, step S150 of executing a print operation B in a band region BR_B, step S160 of executing a workpiece movement operation of moving the workpiece W to a teaching point TPC, and step S170 of executing a print operation C in a band region BR_C, in this order.

The series of processes illustrated in the flowchart illustrated in FIG. 5 is executed by a processing circuit such as a CPU of the computer 700 by reading a program stored in a storage circuit of the computer 700 and executing the read program.

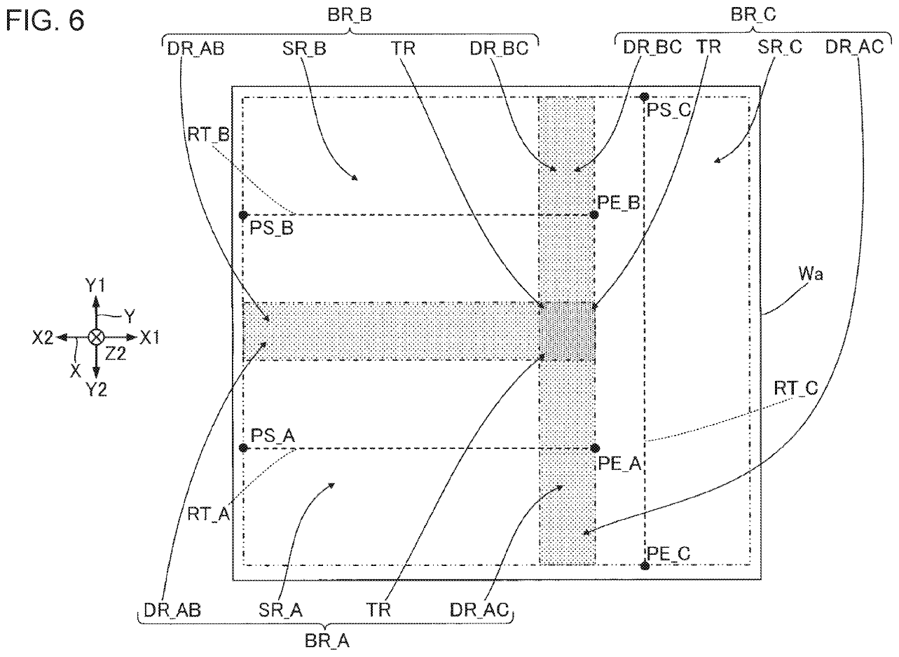

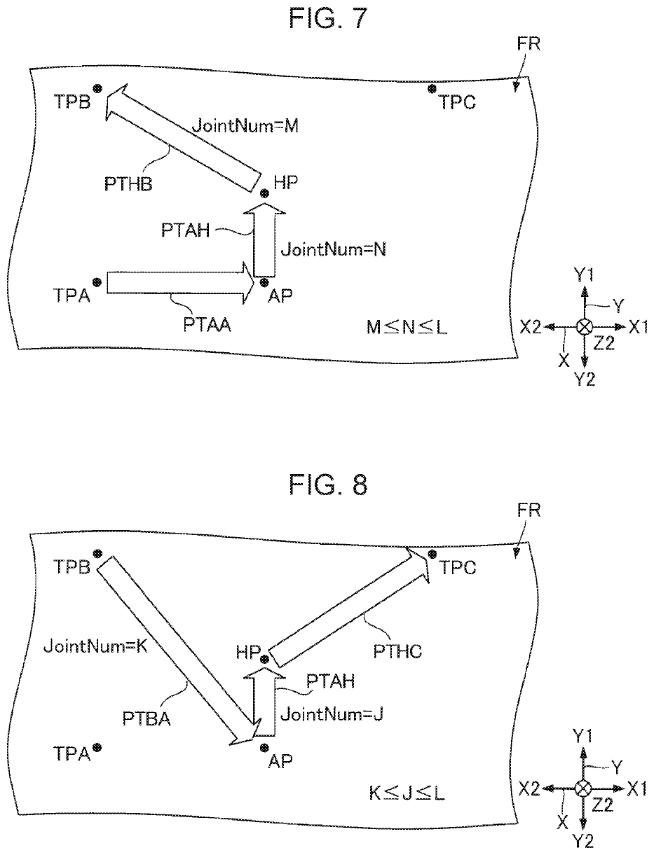

In step S100, the computer 700 receives the teaching point information Da indicating the teaching points TPA, TPB, and TPC based on an operation of the user Ue. Next, in step S110, the computer 700 generates the workpiece trajectory information Db based on the teaching point information Da indicating the teaching points TPA, TPB, and TPC, and generates the head trajectory information Dc based on workpiece information and the workpiece trajectory information Db. The band regions BR_A, BR_B, and BR_C will be described with reference to FIG. 6, and the workpiece movement operation will be described with reference to FIGS. 7 and 8.

FIG. 6 is a view illustrating the print region Wa according to the first embodiment. In the first embodiment, the print region Wa includes the band region BR_A, the band region BR_B, and the band region BR_C.

Here, the band region BR_A is a region of the print region Wa to which ink droplets are applied by the print operation A, the band region BR_B is a region of the print region Wa to which ink droplets are applied by the print operation B, and the band region BR_C is a region of the print region Wa to which ink droplets are applied by the print operation C. In the following description, the band region BR_A, the band region BR_B, and the band region BR_C may be collectively referred to as a band region BR without distinguishing each of the regions. In the first embodiment, the print region Wa includes three band regions BR, but the number of band regions BR is not limited to three. For example, the number of band regions BR included in the print region Wa may be two or four or more.

As illustrated in FIG. 6, each band region BR includes an overlapping region DR which is a region overlapping with another one band region BR and an overlapping region TR which is a region overlapping with other two band regions BR. In other words, the overlapping region DR is a region in which the two band regions BR overlap with each other. The overlapping region TR is a region in which all of the band region BR_A, the band region BR_B, and the band region BR_C overlap with each other. In addition, in the band region BR, a region that does not overlap with the other band region BR may be referred to as a non-overlapping region SR.

Specifically, the band region BR_A includes a non-overlapping region SR_A, an overlapping region DR_AB, an overlapping region DR_AC, and an overlapping region TR. In the following description, an overlapping region DR_xy means a region in which a band region BR_x and a band region BR_y overlap with each other. x and y are any characters of A, B, and C. The band region BR_B includes a non-overlapping region SR_B, an overlapping region DR_AB, an overlapping region DR_BC, and an overlapping region TR. The band region BR_C includes a non-overlapping region SR_C, an overlapping region DR_AC, an overlapping region DR_BC, and an overlapping region TR.

Note that in FIG. 6, as display for convenience, the band region BR is displayed slightly smaller such that a contour of the band region BR does not overlap with a contour of the print region Wa. In addition, in FIG. 6, the overlapping region DR and the overlapping region TR are shaded to make it easier to understand ranges of the overlapping region DR and the overlapping region TR.

As illustrated in FIG. 6, in step S130, the head 310 moves along a head trajectory RT_A and a partial image is formed in the band region BR_A by the print operation A of ejecting ink from the head 310. The movement of the head 310 along any of the paths means that the head scanning mechanism 200 operates such that a tool center point set in the vicinity of the head 310 moves along the path in more detail. The tool center point is a virtual reference point representing the head 310, and is set, for example, at a position moved along an ejection direction DE by several mm from the center or the center of gravity of the nozzle row Ln provided on the nozzle surface FN, for example. Similarly, in step S150, the head 310 moves along a head trajectory RT_B and a partial image is formed in the band region BR_B by the print operation B of ejecting ink from the head 310. In step S170, the head 310 moves along a head trajectory RT_C, and a partial image is formed in the band region BR_C by the print operation C of ejecting ink from the head 310.

The head trajectory RT_A is a trajectory from a start position PS_A toward an end position PE_A. The head trajectory RT_B is a trajectory from a start position PS_B toward an end position PE_B. The head trajectory RT_C is a trajectory from a start position PS_C toward an end position PE_C.

FIG. 7 is a view illustrating the workpiece movement operation in step S140. FIG. 8 is a view illustrating the workpiece movement operation in step S160. In FIGS. 7 and 8, a state in which a range in which the workpiece W can move is viewed in the Z2 direction is illustrated. Further, in FIGS. 7 and 8, display of the workpiece movement mechanism 800 is omitted.

In step S140, the workpiece movement mechanism 800 moves the workpiece W in the order of a trajectory PTAA, a trajectory PTAH, and a trajectory PTHB as illustrated in FIG. 7. The trajectory PTAA is a trajectory from the teaching point TPA to the position AP. The trajectory PTAH is a trajectory from the position AP to the home position HP. The trajectory PTHB is a trajectory from the home position HP to the teaching point TPB.

Further, in step S160, the workpiece movement mechanism 800 moves the workpiece W in the order of a trajectory PTBA, a trajectory PTAH, and a trajectory PTHC, as illustrated in FIG. 8. The trajectory PTBA is a trajectory from the teaching point TPB to the position AP. The trajectory PTHC is a trajectory from the home position HP to the teaching point TPC.

The position AP and the home position HP may be any positions as long as the workpiece W can be moved. However, from the viewpoint of securing a movable region of the workpiece movement mechanism 800 and reducing a movement amount of the teaching point TP from the home position HP, the position where the mounting surface SF of the parallel link mechanism 850 faces the Z1 direction is preferable. In addition, it is preferable that the position AP is set to a position where an operation of moving all of the joints 801 occurs when the workpiece W is moved along the trajectory PTAH to reduce a difference in the amount of backlash at the home position HP. In the trajectory PTAH, all of the joints 801 may operate even slightly, and the movement amount of the workpiece W may be several nanometers. Further, when there is a specific joint 801 that does not operate when the workpiece W is moved from the home position HP to the teaching point TP, the specific joint 801 may not be moved when the workpiece W is moved from the position AP to the home position HP. For example, when only the parallel link mechanism 850 operates in movement from the home position HP to the teaching point TPB, the joints 801_1 to 801_4 may not operate when moving the workpiece W from the position AP to the home position HP.

The position AP and the home position HP may be set by a robot manufacturer or may be set by the user Ue. In the present embodiment, the position AP and the home position HP are set by the robot manufacturer.

In addition, a path from the position AP to the home position HP is preferably the shortest path, but may be a path deviating from the shortest path.

Further, the workpiece movement mechanism 800 may temporarily stop the workpiece W at the position AP and the home position HP, or may allow the workpiece W to pass at a low speed. When productivity is taken into consideration, the workpiece movement mechanism 800 passes the workpiece W at a low speed without temporarily stopping the workpiece W at one or both of the position AP and the home position HP. However, when the workpiece W is not stopped at the position AP and the home position HP, since a positional deviation of the workpiece W when the workpiece W reaches the teaching point TPA becomes large, it is preferable that the workpiece movement mechanism 800 temporarily stops the workpiece W at the position AP and the home position HP.

FIG. 7 illustrates the number “JointNum” of the joints 801 when the workpiece W starts to move from the teaching point TPA. After the workpiece W starts to move from the teaching point TPA, the number of the joints 801 that operate when moving the workpiece W from the position AP to the home position HP is N. Further, after the workpiece W starts to move from the teaching point TPA, the number of the joints 801 that operate when moving the workpiece W from the home position HP to the teaching point TPB is M. As illustrated in FIG. 7, M is equal to or less than L. N is equal to or more than M and equal to or less than L. As described above, it is preferable that N is larger, and it is more preferable that N matches L.

FIG. 8 illustrates the number “JointNum” of the joints 801 when the workpiece W starts to move from the teaching point TPB. After the workpiece W starts to move from the teaching point TPB, the number of the joints 801 that operate when moving the workpiece W from the teaching point TPB to the position AP is K. Further, after the workpiece W starts to move from the teaching point TPB, the number of the joints 801 that operate when moving the workpiece W from the position AP to the home position HP is J. As illustrated in FIG. 8, K is equal to or less than L. J is equal to or more than K and equal to or less than L. As described above, it is preferable that J is larger, and it is more preferable that J matches L.

Note that although the workpiece movement operation in step S120 is not illustrated, the workpiece movement operation is the same as the contents illustrated in FIGS. 7 and 8. Specifically, when the workpiece W is not at the position AP and the home position HP at the start point of time of step S120, the workpiece movement mechanism 800 moves the workpiece W to the teaching point TPA after the workpiece W passes through the position AP and the home position HP in this order.

Note that the band region BR_B corresponds to a “first region”, the band region BR_C corresponds to a “second region”, the overlapping region DR_BC and the overlapping region TR correspond to an “overlapping region”, the print operation B corresponds to a “first print operation”, the print operation C corresponds to a “second print operation”, and the workpiece movement operation in step S160 corresponds to a “movement operation”.

### 1-6. Summary of First Embodiment

As described above, the first embodiment can be defined as a control method of operating the workpiece movement mechanism 800. In the workpiece movement mechanism 800, when moving the workpiece W to the teaching point TPB, the workpiece W moves to the teaching point TPB after passing through the position AP and the home position HP in this order, and when moving the workpiece W to the teaching point TPC, the workpiece W moves to the teaching point TPC after passing through the position AP and the home position HP in this order.

According to the first embodiment, the trajectory PTAH from the position AP to the home position HP can be made common in a trajectory toward the teaching point TPB and a trajectory toward the teaching point TPC. Since the trajectory PTAH is made common, a difference in the amount of backlash can be reduced as compared with an aspect in which there is no common trajectory between the trajectory toward the teaching point TPB and the trajectory toward the teaching point TPC. By reducing the difference in the amount of backlash, the amount of positional deviation of the workpiece W at the teaching point TPB and the teaching point TPC can be reduced.

The workpiece movement mechanism 800 includes L (two or more) joints 801 as a plurality of joints 801, the number of joints 801 that operate when the workpiece W moves from the home position HP to the teaching point TPB among the L joints 801 is M that is equal to or less than L, and the number of joints 801 that operate when the workpiece W moves from the position AP to the home position HP among the L joints 801 is N that is equal to or more than M and equal to or less than L.

According to the first embodiment, as compared with an aspect in which N is less than M, the influence of the backlash of the joint 801 at the home position HP can be further reduced, and as a result, the positional deviation of the workpiece W at the teaching point TPB can be reduced.

In addition, the workpiece movement mechanism 800 includes L (two or more) joints 801 as a plurality of joints 801, the number of joints 801 that operate when the workpiece W moves from the teaching point TPB to the position AP among the L joints 801 is K that is equal to or less than L, and the number of joints 801 that operate when the workpiece W moves from the position AP to the home position HP among the L joints 801 is J that is equal to or more than K and equal to or less than L.

According to the first embodiment, as compared with an aspect in which J is less than K, the influence of the backlash of the joint 801 at the home position HP can be further reduced, and as a result, the positional deviation of the workpiece W at the teaching point TPC can be reduced.

In addition, the number of joints 801 that operate in movement from the teaching point TPB to the position AP among the L joints 801 is K that is equal to or less than L, and the number of joints 801 that operate when the workpiece W moves from the position AP to the home position HP among the L joints 801 is L.

According to the first embodiment, as compared with an aspect in which the number of the joints 801 that operate when the workpiece W moves from the position AP to the home position HP is less than L, the influence of the backlash of the joint 801 at the home position HP can be further reduced. As a result, the positional deviation of the workpiece W at the teaching point TPC can be reduced.

In addition, in the first embodiment, a definition can be made for the control method of controlling the three-dimensional object printing apparatus 100 including the workpiece movement mechanism 800 and the head scanning mechanism 200 supporting the head 310 that ejects ink to the workpiece W. The control method includes the print operation B in which the head scanning mechanism 200 moves the head 310 relative to the workpiece W while ink is ejected from the head 310 to the band region BR_B of the workpiece W in a state in which the workpiece movement mechanism 800 has stopped the workpiece W at the teaching point TPB, the print operation C in which the head scanning mechanism 200 moves the head 310 relative to the workpiece W while ink is ejected from the head 310 to the band region BR_C of the workpiece W in a state in which the workpiece movement mechanism 800 has stopped the workpiece W at the teaching point TPC, and the workpiece movement operation in which the workpiece W passes through the position AP and the home position HP in this order when moving the workpiece W from the teaching point TPB to the teaching point TPC between the print operation B and the print operation C. In the three-dimensional object printing apparatus 100, when the positional deviation of the workpiece W is caused to occur between the print operation B and the print operation C, the printing unevenness and the white stripe are generated. According to the first embodiment, it is possible to suppress the amount of positional deviation at the teaching point TPB and the teaching point TPC, and thus it is possible to suppress the occurrence of the printing unevenness and the white stripe.

The band region BR_B and the band region BR_C include the overlapping region DR_BC and the overlapping region TR that overlap with each other.

In the overlapping region DR_BC and the overlapping region TR, when one or both of the band region BR_B and the band region BR_C are deviated, a white stripe or a black stripe is generated, and the quality of an image formed in the print region Wa is deteriorated. The black stripe is a dark stripe generated when ink adheres duplicately due to unintentional overlapping of adjacent band regions BR. Therefore, according to the first embodiment, it is possible to suppress the deviation of one or both of the band region BR_B and the band region BR_C, and thus it is possible to suppress the occurrence of the white stripe or the black stripe.

In addition, according to the first embodiment, in the workpiece movement mechanism 800 that supports the workpiece W, when moving the workpiece W to the teaching point TPB, the workpiece W moves to the teaching point TPB after passing through the position AP and the home position HP in this order, and when moving the workpiece W to the teaching point TPC, the workpiece W moves to the teaching point TPC after passing through the position AP and the home position HP in this order.

In addition, in the first embodiment, a definition can also be made for a program for causing the workpiece movement mechanism 800 that supports the workpiece W to execute a step of causing the workpiece W to move to the teaching point TPB after passing through the position AP and the home position HP in this order when the workpiece W moves to the teaching point TPB, a step of causing the workpiece W to move to the teaching point TPC after passing through the position AP and the home position HP in this order when the workpiece W moves to the teaching point TPC.

### 2. Modification Example

Each aspect exemplified above can be variously modified. A specific aspect of the modification will be described below. Two or more aspects optionally selected from the following examples can be combined as appropriate insofar as the aspects are not mutually contradictory.

### 2-1. First Modification Example

A deviation may occur between a coordinate value of the teaching point TP input by the user Ue and a coordinate value of an actual space. The deviation is generated by a shape of the workpiece W, an individual difference of the workpiece movement mechanism 800, and the like, and is different depending on a position in a movable range of the workpiece movement mechanism 800. Therefore, it is conceivable to measure the deviation between the coordinate value of the input teaching point TP and the coordinate value of the actual space at one or more positions within the movable range of the workpiece movement mechanism 800. However, the user Ue may not have an apparatus for measuring an error, which is a deviation amount between the coordinate value of the teaching point TP and the coordinate value of the actual space. Therefore, in the first modification example, a generation process of generating a correction calculation table HT relating to the error is executed by using a motion capture device 900 possessed by a robot manufacturer who is a developer of a three-dimensional object printing apparatus 100A, and the three-dimensional object printing apparatus 100A in the first modification example executes a correction process by using the correction calculation table HT. Hereinafter, the first modification example will be described.

### 2-1-1. Environment for Executing Generation Process

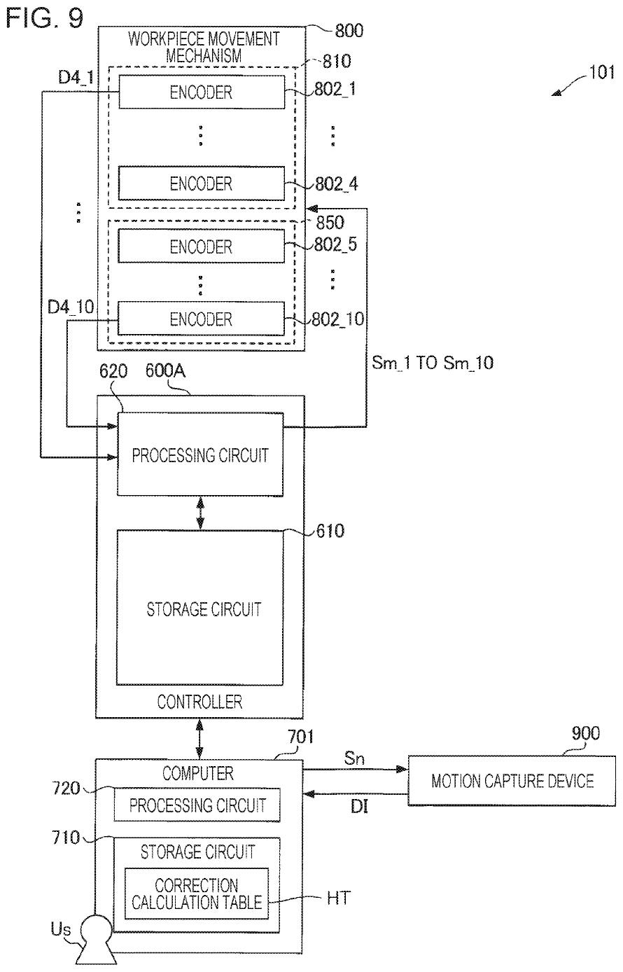

FIG. 9 is a view illustrating an example of a configuration of a measurement system 101 that executes the generation process. The measurement system 101 includes a controller 600A, a workpiece movement mechanism 800, a computer 701, and a motion capture device 900. The measurement system 101 is used by the robot manufacturer Us of the three-dimensional object printing apparatus 100A according to the first modification example.

The computer 701 is a PC used by the robot manufacturer Us. The computer 701 includes a storage circuit 710 and a processing circuit 720. The storage circuit 710 includes a semiconductor memory of one or both of a volatile memory such as a RAM and a non-volatile memory such as a ROM, an EEPROM, or a PROM. Note that a part of all of the storage circuit 710 may be included in the processing circuit 720. Further, the storage circuit 710 stores the correction calculation table HT generated by the generation process.

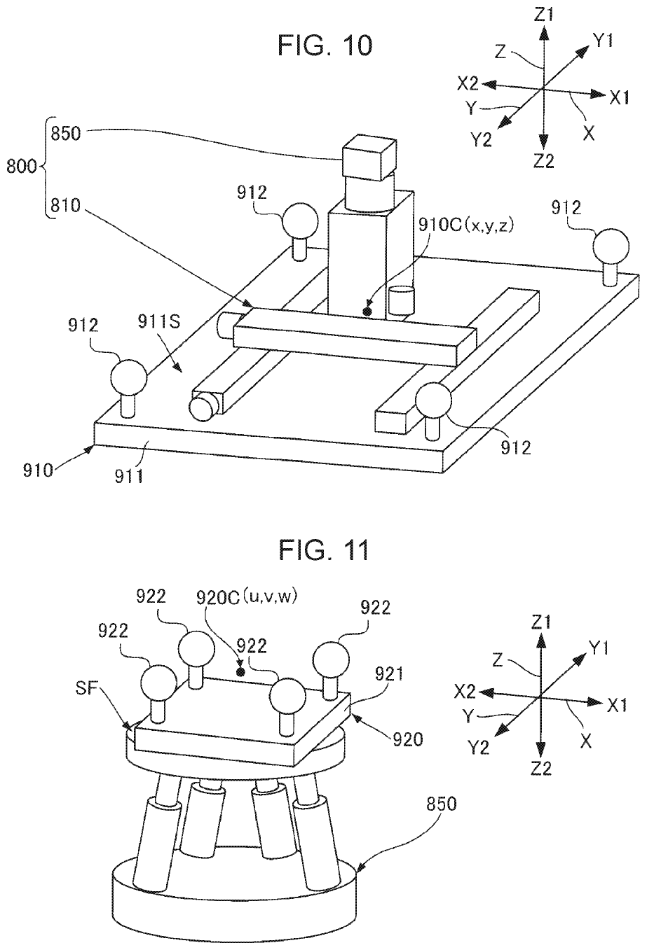

The motion capture device 900 is a device that records a movement of a target object such as a person, an animal, or an object by a motion capture technique and outputs a three-dimensional coordinate value of the target object. In the motion capture technique, there are an optical method in which a marker is attached to the target object and the three-dimensional coordinate value of the target object is output by imaging the marker with a plurality of cameras, and an inertial sensor method in which an inertial sensor including an angular velocity sensor and an acceleration sensor is attached to an object or the like and a three-dimensional coordinate value of the target object is output based on a measurement result of the inertial sensor. The motion capture device 900 according to the first modification example outputs the three-dimensional coordinate value of the target object by the optical method. The robot manufacturer Us attaches a marker to the workpiece movement mechanism 800 before executing the generation process. An example of attaching the marker to the workpiece movement mechanism 800 will be described with reference to FIGS. 10 and 11.

FIGS. 10 and 11 are views illustrating a state in which the marker is attached to the workpiece movement mechanism 800. Before executing the generation process, the robot manufacturer Us attaches a jig 910 to an XYZθ movement mechanism 810 and attaches a jig 920 to a parallel link mechanism 850. FIG. 10 illustrates a state in which the jig 910 is attached to the XYZθ movement mechanism 810. Further, in FIG. 10, to prevent the drawing from being complicated, a shape of the parallel link mechanism 850 is shown in a simplified manner as in FIG. 1. Further, in FIG. 10, display of the jig 920 is omitted. FIG. 11 illustrates a state in which the jig 920 is attached to the parallel link mechanism 850.

As illustrated in FIG. 10, the jig 910 includes a flat plate-shaped member 911 that is substantially parallel to an XY plane and four markers 912. The XYZθ movement mechanism 810 is mounted on a surface 911S of the member 911 which faces the Z1 direction.

As illustrated in FIG. 11, the jig 920 includes a flat plate-shaped member 921 and four markers 922. The jig 920 is fixed onto a mounting surface SF of the parallel link mechanism 850. Note that the jig 920 is an example of a “support for measurement”.

The description will now return to FIG. 9. When an analysis instruction Sn is received from the computer 701, the motion capture device 900 captures images of the four markers 912 of the jig 910 and the markers 922 of the jig 920. The motion capture device 900 transmits measurement information DI indicating a measurement value obtained by measuring coordinate values (x, y, z) of the center 910C of the four markers 912 and coordinate values (u, v, w) of the center 920C of the four markers 922 by analyzing the captured image to the computer 701. That is, the measurement information DI has six values of (x, y, z, u, V, w).

Note that the motion capture device 900 is an example of a “measurement device that measures an actual position of a support for measurement when a robot moves the support for measurement to a measurement point”.

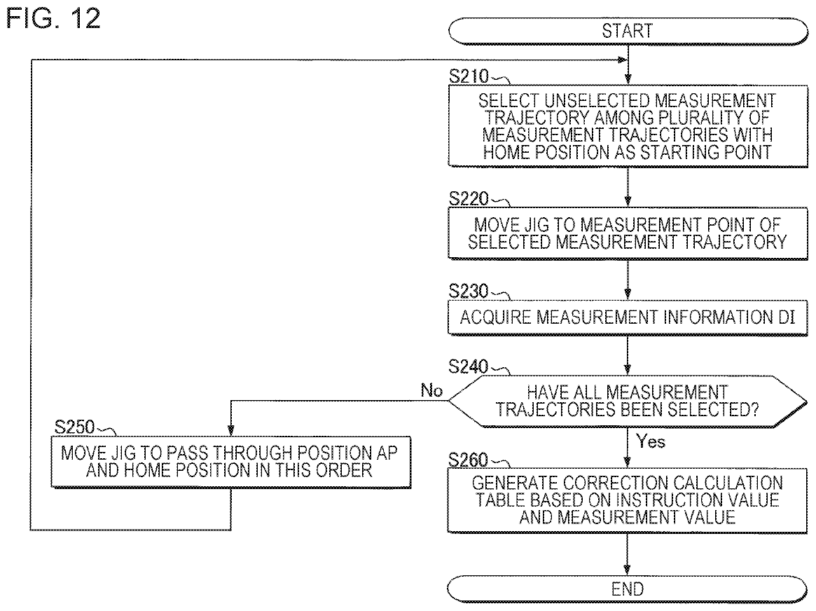

FIG. 12 is a flowchart illustrating an example of the generation process. A series of flowchart illustrated in FIG. 12 is realized by the processing circuit 720 by reading a program stored in the storage circuit 710 and executing the read program.

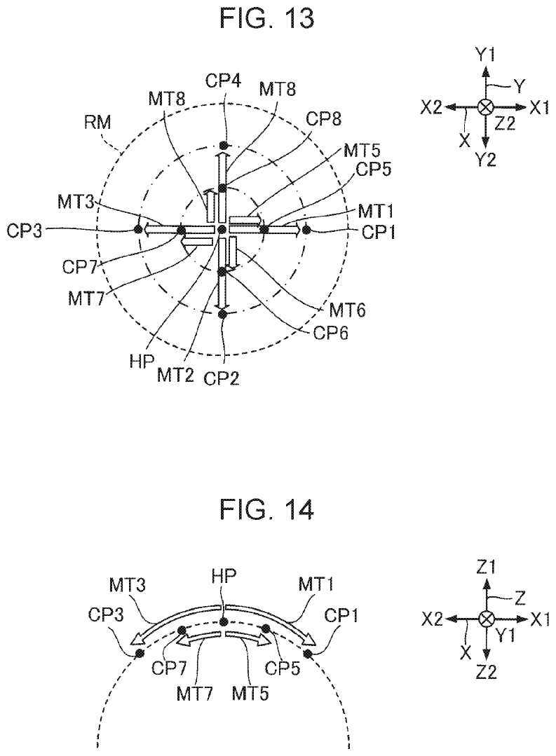

In step S210, the processing circuit 720 selects an unselected measurement trajectory MT among a plurality of measurement trajectories MT with the home position HP as a starting point. The storage circuit 710 stores measurement trajectory information indicating a measurement trajectory MT of each of the plurality of measurement trajectories MT. The measurement trajectory MT will be described with reference to FIGS. 13 and 14.

FIG. 13 is a view illustrating the plurality of measurement trajectories MT viewed in the Z2 direction. FIG. 13 illustrates the measurement trajectories MT1 to MT8. Hereinafter, the measurement trajectories MT1 to MT8 may be referred to as a measurement trajectory MT without distinction. Each of the eight measurement trajectories MT8 is a trajectory from the home position HP to any of the measurement points CP1 to CP8. Hereinafter, the measurement points CP1 to CP8 may be referred to as a measurement point CP without distinction. FIG. 14 is a view illustrating the plurality of measurement trajectories MT viewed in the Y1 direction. In FIG. 14, among the eight measurement trajectories MT8, the measurement trajectories MT1, MT3, MT5, and MT7 are shown. However, the number of the measurement trajectories MT may be one or more.

In FIG. 13, the measurement point CP5 is present in the middle of the measurement trajectory MT1, the measurement point CP6 is present in the middle of the measurement trajectory MT2, the measurement point CP7 is present in the middle of the measurement trajectory MT3, and the measurement point CP8 is present in the middle of the measurement trajectory MT4. Therefore, the measurement trajectory MT5 overlaps with the measurement trajectory MT1, the measurement trajectory MT6 overlaps with the measurement trajectory MT2, the measurement trajectory MT7 overlaps with the measurement trajectory MT3, and the measurement trajectory MT8 overlaps with the measurement trajectory MT4. In FIG. 13, for convenience of description, the measurement trajectories MT5 to MT8 are displayed in a state of being deviated from the original positions.

The measurement trajectories MT illustrated in FIGS. 13 and 14 are trajectories in which the upper joint portion 8523 is lowered from the home position HP. In a plan view, the measurement trajectories MT1 to MT8 are trajectories separated from the home position HP at intervals of 90 degrees.

The description will return to FIG. 12. In step S220, the processing circuit 720 inputs a coordinate value of the measurement point CP of the measurement trajectory MT selected in step S210 to the controller 600 to move the jig 920 to the measurement point CP of the measurement trajectory MT selected in step S210. In the following description, the coordinate values input to the controller 600 may be referred to as an “instruction value”.

After the process of step S220 is ended, in step S230, the processing circuit 720 transmits the analysis instruction Sn to the motion capture device 900, and acquires the measurement information DI, which is a measurement value obtained by measuring the center 920C of the jig 920 at the measurement point CP, from the motion capture device 900. The coordinate values input to the controller 600 are also six values, which are the coordinate values (x, y, z) of the center 910C and the coordinate values (u, v, w) of the center 920C, similar to the measurement information DI. In the following, for easy understanding, the measurement values (x, y, z, u, v, w) included in the measurement information DI may be described as (x, y, z′, u′, v′, w′).

After the process of step S230 is ended, the processing circuit 720 determines whether or not all of the measurement trajectories MT are selected in step S240. When the determination result in step S240 is negative, in step S250, the processing circuit 720 moves the jig 920 to pass through the position AP and the home position HP in this order. After the process of step S240 is ended, the processing circuit 720 returns the process to step S210.

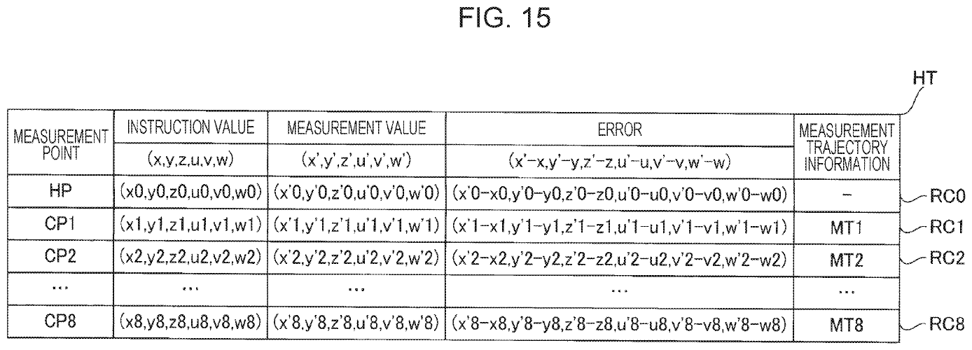

When the determination result in step S240 is positive, in step S260, the processing circuit 720 generates the correction calculation table HT based on the instruction value input by the process of step S220, the measurement value acquired by the process of step S230, and the measurement trajectory information. After the process of step S260 is ended, the processing circuit 720 ends the series of processes illustrated in FIG. 12. The correction calculation table HT will be described with reference to FIG. 15.

FIG. 15 is a table illustrating an example of the content of the correction calculation table HT. The correction calculation table HT includes a record RC having an instruction value, a measurement value, an error obtained by subtracting the instruction value from the measurement value, and measurement trajectory information indicating the measurement trajectory MT for each measurement point CP. In the example of FIG. 15, the correction calculation table HT includes records RC1 to RC8 corresponding to the measurement points CP1 to CP8 illustrated in FIGS. 13 and 14. Further, the correction calculation table HT illustrated in FIG. 15 includes a record RC0 corresponding to the home position HP.

In step S260, the processing circuit 720 generates, for each measurement point CP, instruction values (x, y, z, u, v, w), measurement values (x), y, z′, u′, v′, w′), an error (x′-x, y′-y, z′-z, u′-u, v′-v, w′-w) obtained by subtracting the instruction values from the measurement values, and the measurement trajectory information indicating the measurement trajectory MT from the home position HP to the measurement point CP as one record RC.

Note that the correction calculation table HT is an example of “error information” regarding the error between an actual position of the workpiece W and an instruction value of the teaching point TP when the workpiece movement mechanism 800 moves the workpiece W to the teaching point TP.

Further, when the measurement trajectory MT from the home position HP to each measurement point CP can be uniquely specified, the correction calculation table HT may not include the measurement trajectory information. Further, the correction calculation table HT includes the instruction value, the measurement value, and the error, but may include only two pieces of information among the instruction value, the measurement value, and the error.

### 2-1-2. Environment for Executing Correction Process

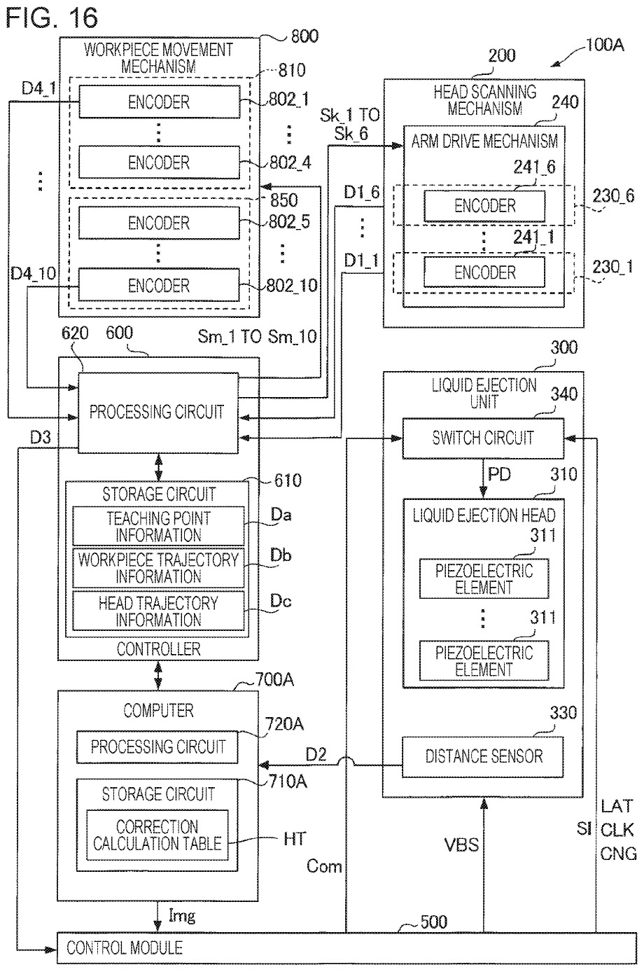

FIG. 16 is a block diagram illustrating an electrical configuration of the three-dimensional object printing apparatus 100A according to the first modification example. In FIG. 16, to prevent the drawing from being complicated, the configuration of the control module 500 is shown in a simplified manner. The three-dimensional object printing apparatus 100A is different from the three-dimensional object printing apparatus 100 in that a computer 700A is provided instead of the computer 700. The computer 700A includes a storage circuit 710A and a processing circuit 720A.

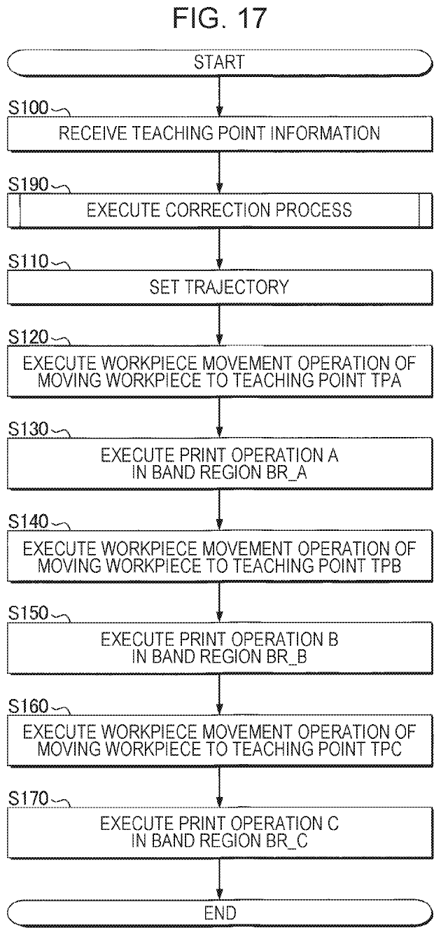

The storage circuit 710A stores various programs executed by the processing circuit 720A, various kinds of data processed by the processing circuit 720A, and the correction calculation table HT. The storage circuit 710A includes, for example, a semiconductor memory of one or both of a volatile memory such as a RAM and a non-volatile memory such as a ROM, an EEPROM, or a PROM. Note that a part or all of the storage circuit 710A may be included in the processing circuit 720A. For example, when the computer 700A is connected to a Web server managed by the robot manufacturer Us, the computer 700A downloads the correction calculation table HT from the Web server and stores the correction calculation table HT in the storage circuit 710A. The processing circuit 720A includes, for example, one or more processors such as a CPU. Note that the processing circuit 720A may include a programmable logic device such as an FPGA instead of or in addition to the CPU. FIG. 17 is a flowchart illustrating a flow of the three-dimensional object printing method according to the first modification example. The flowchart illustrated in FIG. 17 is different from the flowchart illustrated in FIG. 5 in that step S190 is executed after step S100.

Hereinafter, only differences from the flowchart illustrated in FIG. 5 will be described.

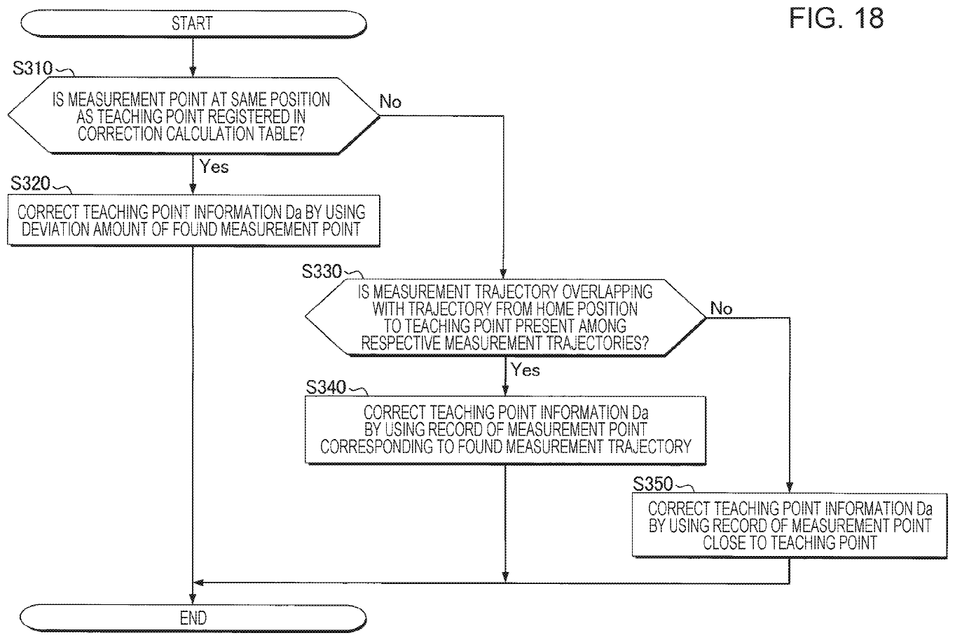

After the process of step S100 is ended, the processing circuit 720A executes a correction process in step S190. The correction process will be described with reference to FIG. 18.

FIG. 18 is a flowchart illustrating a correction process. The correction process is a process of correcting the movement operation in which the workpiece movement mechanism 800 moves the workpiece W to the teaching point TP based on the instruction value of the teaching point TP and the correction calculation table HT. For simplification of the description, the description will be made on the assumption that one teaching point TP is indicated in the teaching point information Da. When a plurality of the teaching points TP are indicated in the teaching point information Da, the processing circuit 720A executes a series of processes illustrated in FIG. 18 for each teaching point TP.

In Step S310, the processing circuit 720A determines whether or not the measurement point CP at the same position as the teaching point TP is registered in the correction calculation table HT. When the determination result in step S310 is positive, in step S320, the processing circuit 720A corrects the teaching point information Da such that an error at the teaching point TP is offset by an error of the measurement point CP found in step S310. For example, when the instruction value of the teaching point TP is an instruction value at which a posture of the workpiece W is 90 degrees, and the measurement value of the teaching point TP is a measurement value at which the posture of the workpiece W is 91 degrees, the processing circuit 720A corrects the instruction value of the teaching point TP in the teaching point information Da by using the error of the measurement point CP such that the instruction value of the teaching point TP becomes 89 degrees to set the posture of the workpiece W to 90 degrees.

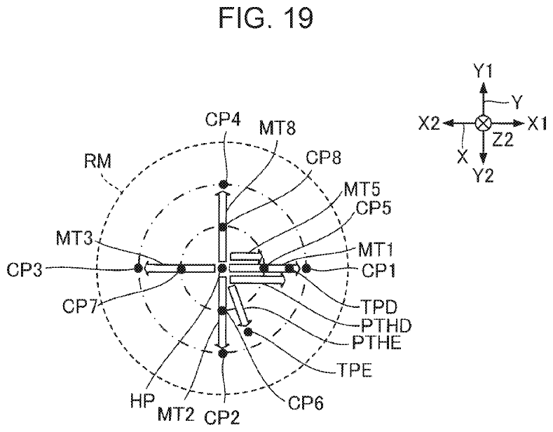

On the other hand, when the determination result in step S310 is negative, in step S330, the processing circuit 720A determines whether or not a measurement trajectory MT that overlaps with a trajectory from the home position HP to the teaching point TP is present among measurement trajectories MT from the home position HP to each measurement point CP. When the determination result in step S330 is positive, in step S340, the processing circuit 720A corrects the teaching point information Da by using the error of the measurement point CP corresponding to the measurement trajectory MT found in step S330. A specific correction example by the process of step S340 will be described later with reference to FIG. 19.

When the determination result in step S330 is negative, in step S350, the processing circuit 720A corrects the teaching point information Da by using the error of the measurement point CP close to the teaching point TP. A specific correction example by the process of step S350 will be described later with reference to FIG. 19.

After the process of any one of steps S320, S340, and S350 is ended, the processing circuit 720A ends the series of processes illustrated in FIG. 18. The process of step S340 and the process of step S350 will be described with reference to FIG. 19.

FIG. 19 is a view illustrating the process of step S340 and the process of step S350. In FIG. 19, a teaching point TPD and a teaching point TPE are further shown as compared with FIG. 13. The teaching point information Da includes an instruction value of the teaching point TPD and an instruction value of the teaching point TPE. Note that in FIG. 19, a part of the display of the measurement trajectory MT is omitted to prevent the drawing from being complicated.

For the teaching point TPD, in step S330, the processing circuit 720A determines that two measurement trajectories MT including the measurement trajectory MT1 and the measurement trajectory MT5 overlapping with a trajectory PTHD from the home position HP to the teaching point TPD are present among the respective measurement trajectories MT. Specifically, as can be seen from FIG. 19, the teaching point TPD and the measurement point CP5 are positioned on the measurement trajectory MT1. Therefore, the processing circuit 720A corrects the teaching point information Da based on a record RC of one or both of a record RC1 of the measurement point CP1 corresponding to the measurement trajectory MT1 and a record RC5 of the measurement point CP5 corresponding to the measurement trajectory MT5, and the instruction value of the teaching point TPD. For example, the processing circuit 720A estimates an error of the teaching point TPD based on the record RC1 and the instruction value of the teaching point TPD. After estimating the error of the teaching point TPD, the processing circuit 720A corrects the teaching point information Da by adding or subtracting the estimated error of the teaching point TPD to or from the instruction value of the teaching point TPD in a similar manner as in the process of step S320. As an example of estimating the error of the teaching point TPD, for simplification of description, when it is assumed that the error between the instruction value and the measurement value of the home position HP is 0, the processing circuit 720A calculates the error at the teaching point TPD according to linear interpolation, specifically, according to the following Equation (1).

Error of teaching point TPD=Error of measurement point CP1×(length of trajectory PTHD)/(length of measurement trajectory MT1) (1)

Even in the aspect of estimating the error of the teaching point TPD based on the record RC5 and the instruction value of the teaching point TPD, the processing circuit 720A may replace the measurement point CP1 in the equation (1) with the measurement point CP5. Further, even in the aspect of estimating the error of the teaching point TPD based on the record RC1 and the record RC5, and the instruction value of the teaching point TPD, the processing circuit 720A may estimate the error of the teaching point TPD by linear interpolation between the two points.

Note that in FIG. 19, when the teaching point TPD corresponds to a “first teaching point”, the measurement point CP1 corresponds to a “first measurement point”, the measurement trajectory MT1 corresponds to a “first trajectory from the first point toward the first measurement point,” and the record RC1 corresponds to “first information indicating an error relationship between an instruction value of the first measurement point, which is a coordinate value input when moving the support for measurement from the first point to the first measurement point, and a measurement value of the first measurement point which is obtained by measuring an actual position of the support for measurement when the robot moves the support for measurement to the first measurement point”. In addition, the measurement point CP5 corresponds to a “second measurement point”, and the record RC5 corresponds to “second information indicating an error relationship between an instruction value of the second measurement point, which is a coordinate value input when the support for measurement is moved from the first point to the second measurement point, and a measurement value of the second measurement point which is obtained by measuring an actual position of the support for measurement when the robot moves the support for measurement to the second measurement point”.

For the teaching point TPE, in step S330, the processing circuit 720A determines that there is no trajectory overlapping with a trajectory PTHE from the home position HP to the teaching point TPE in each of the measurement trajectories MT. Therefore, in step S350, the processing circuit 720A corrects the teaching point information Da by using the record RC of the measurement point CP close to the teaching point TPE. As can be seen from FIG. 19, a measurement point CP closest to the teaching point TPE among the measurement points CP1 to CP8 is the measurement point CP2. Therefore, the processing circuit 720A corrects the teaching point information Da based on a record RC2 of the measurement point CP2 and the instruction value of the teaching point TPE. Specifically, the processing circuit 720A may estimate the error of the teaching point TPE by replacing the measurement point CP1 in the equation (1) with the measurement point CP2.

Note that in FIG. 19, when the teaching point TPE corresponds to the “first teaching point”, the measurement point CP2 corresponds to the “first measurement point”, the measurement trajectory MT2 corresponds to the “first trajectory from the first point toward the first measurement point”, and the record RC2 corresponds to the “first information”. In addition, any measurement point CP among the measurement points CP1 and CP3 to 8 corresponds to a “second measurement point”, and the record RC corresponding to any measurement point CP corresponds to the “second information”.

In addition, in the above description, the processing circuit 720A corrects the teaching point information Da based on the record RC of the measurement point CP closest to the teaching point TPE among the measurement points CP1 to CP8, and the instruction value of the teaching point TPE, but the present disclosure is not limited thereto. For example, the processing circuit 720A may correct the teaching point information Da based on the record RC of a plurality of measurement points CP close to the teaching point TPE among the measurement points CP1 to CP8, and the instruction value of the teaching point TPE. In the example of FIG. 19, the processing circuit 720A may correct the teaching point information Da based on the record RC of each of the measurement points CP1, CP2, CP5, and CP6 positioned near the teaching point TPE among the measurement points CP1 to CP8, and the instruction value of the teaching point TPE.

The description will now return to FIG. 17. After the process in step S190 is ended, in step S110, the computer 700A generates the workpiece trajectory information Db based on the teaching point information Da indicating the teaching points TPA, TPB, and TPC, and generates the head trajectory information Dc based on the workpiece information and the workpiece trajectory information Db. Since the teaching point information Da at the point of time of step S110 is a value corrected by the correction process, the workpiece movement operation in each of step S120, step S140, and step S160 is corrected. However, the correction method for the workpiece movement operation is not limited thereto. For example, the processing circuit 720A of the computer 700A may not execute step S110 after step S100, and may control the head scanning mechanism 200 to move the workpiece W by an error of the teaching point TP in each of the processes of step S120, step S140, and step S160. More specifically, the processing circuit 720A may estimate the error of the teaching point TPA by using a part of the series of processes illustrated in FIG. 18 before step S120, and may control the head scanning mechanism 200 such that the estimated error of the teaching point TPA is offset.

### 2-1-3. Summary of First Modification Example

In the above, in the control method in the first modification example, the head scanning mechanism 200 corrects the workpiece movement operation in which the head scanning mechanism 200 moves the workpiece W to the teaching point TP based on the instruction value of the teaching point TP, which is the coordinate value input when moving the workpiece W from the home position HP to the teaching point TP, and the correction calculation table HT which is the error information on the error between the actual position of the workpiece W when the head scanning mechanism 200 moves the support for measurement to the teaching point TP and the instruction value of the teaching point TP.

As described above, an error may occur between the instruction value of the teaching point TP and the actual position. According to the first modification example, the positional deviation of the workpiece W at the teaching point TP can be reduced by correcting the error.

In addition, the correction calculation table HT includes the record RC1 indicating a relationship of the error between the instruction value of the measurement point CP1 which is the coordinate value input when moving the jig 920 from the home position HP to the measurement point CP1, and the measurement value of the measurement point CP1 which is obtained by measuring the actual position of the jig 920 when the head scanning mechanism 200 moves the jig 920 to the measurement point CP1.

According to the first modification example, the error between the instruction value of the teaching point TP and the actual position can be corrected based on the correction calculation table HT. In addition, the correction calculation table HT is limited to the error of the measurement point CP in movement from the home position HP to the measurement point CP. That is, the number of measurement trajectories MT included in the correction calculation table HT is limited. Therefore, according to the first modification example, since the number of measurement trajectory information of the correction calculation table HT is limited as compared with a case where the correction calculation table HT includes countless measurement trajectory information representing measurement trajectories MT, the data amount of the correction calculation table HT can be reduced.

In addition, when the teaching point TPD illustrated in FIG. 19 is used, the correction calculation table HT includes the record RC1 and the record RC5. When the measurement trajectory MT1 from the home position HP toward the measurement point CP1 is set as the first trajectory, and the teaching point TPD and the measurement point CP5 are positioned on the first trajectory, the movement operation in which the head scanning mechanism 200 moves the workpiece W to the teaching point TPD is corrected based on information of one or both of the record RC1 and the record RC5 and the instruction value of the teaching point TPD.

The teaching point TP may not match the measurement point CP depending on the shape of the workpiece W and the demand of the user Ue. According to the first modification example, the positional deviation at the teaching point TP can be corrected even when the teaching point TP does not match the measurement point CP. Further, when there is a portion common to two trajectories, it can be said that a difference in the amount of backlash at the end points of the two trajectories tends to be smaller as compared with a case where there is no portion common to the two trajectories. The first trajectory and the measurement trajectory MT5 from the home position HP toward the measurement point CP5 have a common portion with the trajectory PTHD from the home position HP toward the teaching point TPD. Therefore, according to the first modification example, the positional deviation of the workpiece W at the teaching point TP can be reduced as compared with an aspect in which the record RC of the measurement point CP, which is an end point of a trajectory that does not have the common portion with the trajectory from the home position HP to the teaching point TPD, is used.

In addition, when the “first measurement point” is the measurement point CP2, the “second measurement point” is the measurement point CP6, and the measurement trajectory MT2 from the home position HP toward the measurement point CP2 is the “first trajectory” by using the teaching point TPE illustrated in FIG. 19, and when the teaching point TPE and the measurement point CP6 are not positioned on the first trajectory, the measurement point CP close to the teaching point TPE is determined between the measurement point CP2 and the measurement point CP6, and when it is determined that the measurement point CP2 is closer to the teaching point TPE as compared with the measurement point CP6, the head scanning mechanism 200 corrects the workpiece movement operation of moving the workpiece W to the teaching point TPE based on the record RC2 and the instruction value of the teaching point TPE.

It can be said that the error of the measurement point CP close to the teaching point TPE is closer to the error of the teaching point TPE as compared with the error of the measurement point CP far from the teaching point TP. Therefore, according to the first modification example, the positional deviation of the workpiece W at the teaching point TP can be reduced as compared with an aspect in which the record RC of the measurement point CP far from the teaching point TP is used.

Further, the record RC corresponding to the measurement point CP in the correction calculation table HT is generated based on the measurement result of the motion capture device 900 for measuring an actual position of the jig 920 when the head scanning mechanism 200 moves the jig 920 to the measurement point CP and the instruction value of the measurement point CP.

### 2-2. Second Modification Example

In the first modification example, it is described that a deviation may occur between the instruction value of the teaching point TP input by the user Ue and the coordinate value of the actual space. This deviation may also occur due to the weight of the workpiece W. Therefore, in the second modification example, the head scanning mechanism 200 corrects the workpiece movement operation of moving the workpiece W to the teaching point TPE in correspondence with the weight of the workpiece W.

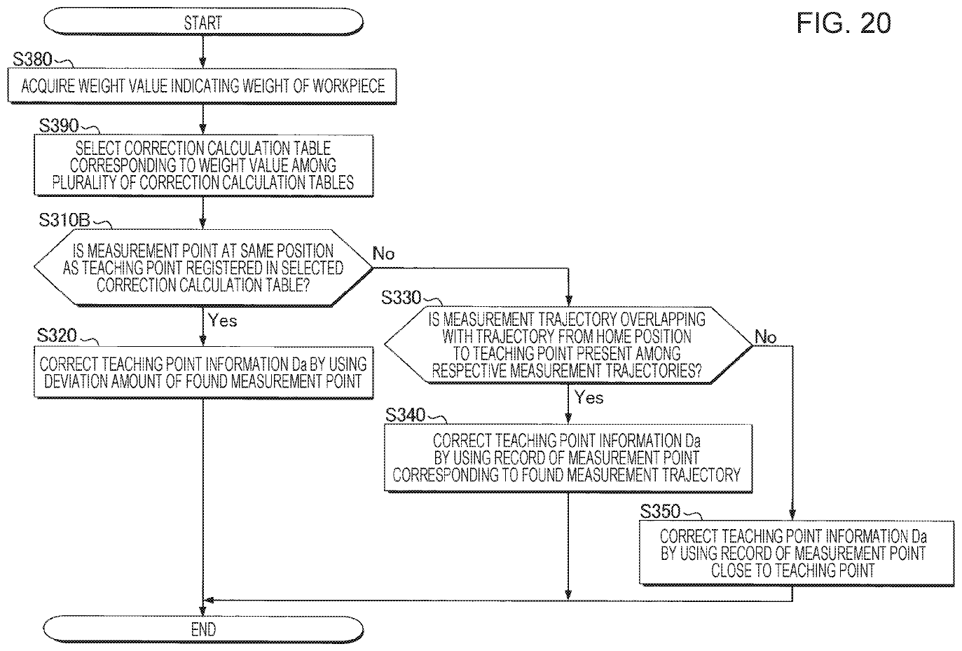

In a generation process in the second modification example, the measurement system 101 in the second modification example executes the generation process for each of a plurality of jigs 920 having different weights, generates the correction calculation table HT corresponding to each of the plurality of jigs 920, and stores the correction calculation table HT in the storage circuit 710 in association with the weight value of the jig 920. The correction process in the second modification example will be described with reference to FIG. 20.

FIG. 20 is a flowchart illustrating the correction process in the second modification example. The flowchart illustrated in FIG. 20 is different from the flowchart illustrated in FIG. 18 in that a process of step S310B is executed instead of the process of step S310, and processes of step S380 and step S390 are further executed before the process of step S310B. Hereinafter, only differences from the flowchart illustrated in FIG. 18 will be described.

In step S380, the processing circuit 720A acquires a weight value indicating the weight of the workpiece W. As a method of acquiring the weight value, for example, the workpiece movement mechanism 800 in the second modification example may include a weight scale, and the processing circuit 720A may acquire the weight value from the weight scale. Alternatively, the weight value may be acquired by causing the user Ue to input the weight value.

After the process of step S380 is ended, in step S390, the processing circuit 720A selects a correction calculation table HT corresponding to the weight value acquired in step S380 among a plurality of correction calculation tables HT. Specifically, the processing circuit 720A selects the correction calculation table HT associated with the weight value closest to the weight value acquired in step S380. After the process of step S390 is ended, in step S310B, the processing circuit 720A determines whether or not the measurement point CP at the same position as the teaching point TP is registered in the correction calculation table HT selected in step S390. In the subsequent series of processes from step S320 to step S350, the processing circuit 720A performs the process by using each record RC of the correction calculation table HT selected in step S390.

In the above, the control method in the second modification example corrects the workpiece movement operation in which the workpiece movement mechanism 800 moves the workpiece W to the teaching point TP based on the weight value indicating the weight of the workpiece W, the instruction value of the teaching point TP, and the correction calculation table HT.

As described above, the deviation between the instruction value of the teaching point TP and the coordinate value of the actual space may occur depending on the weight of the workpiece W. Specifically, as the weight of the workpiece W increases, a force applied to the plurality of joints 801 included in the workpiece movement mechanism 800 may fluctuate, and the positional deviation may occur. According to the second modification example, since the weight of the workpiece W is considered as one parameter of the correction, the positional deviation of the workpiece W due to the difference in the weight of the workpiece W can be reduced.

### 2-3. Third Modification Example

In the first modification example and the second modification example, the number of markers attached to the workpiece movement mechanism 800 is not limited to eight. For example, in the first modification example, the jig 920 including four markers 922 is attached to the parallel link mechanism 850, but for example, four more markers may be provided in a height direction of the jig 920.

### 2-4. Fourth Modification Example

In each of the above-described aspects, the workpiece movement mechanism 800 is controlled to move the workpiece W to the teaching point TP after the workpiece W passes through the position AP and the home position HP in this order, but the present disclosure is not limited thereto. The workpiece movement mechanism 800 may be controlled to move the workpiece W to the teaching point TP after the workpiece W passes through the home position HP. A fourth modification example will be described below.

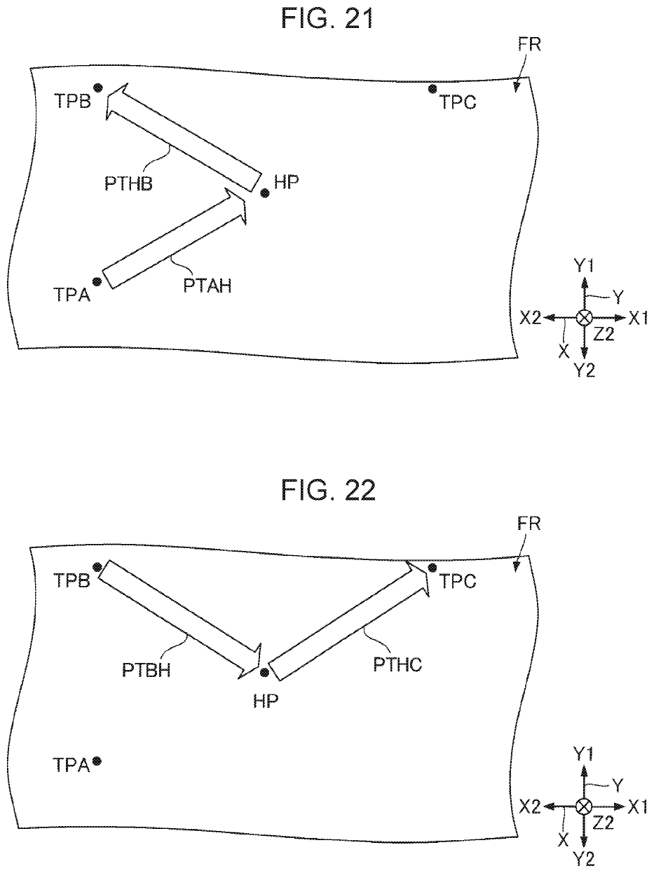

FIGS. 21 and 22 are views illustrating a workpiece movement operation in the fourth modification example. FIG. 21 illustrates the workpiece movement operation in movement from the teaching point TPA toward the teaching point TPB, and FIG. 22 illustrates the workpiece movement operation in movement from the teaching point TPB toward the teaching point TPC.

When moving the workpiece W from the teaching point TPA toward the teaching point TPB, the workpiece movement mechanism 800 moves the workpiece W in the order of a trajectory PTAH and a trajectory PTHB as illustrated in FIG. 21. The trajectory PTAH is a trajectory from the teaching point TPA to the home position HP. In addition, when moving the workpiece W from the teaching point TPB toward the teaching point TPC, the workpiece movement mechanism 800 moves the workpiece W in the order of the trajectory PTBH and the trajectory PTHC as illustrated in FIG. 22. The trajectory PTBH is a trajectory from the teaching point TPB to the home position HP.

In the above, in the control method according to the fourth modification example, when moving the workpiece W to the teaching point TPB, the workpiece W moves to the teaching point TPB after passing through the home position HP, and when moving the workpiece W to the teaching point TPC, the workpiece W moves to the teaching point TPC after passing through the home position HP.

According to the fourth modification example, by moving the workpiece W from the home position HP to the teaching point TP, it is possible to reduce the positional deviation at the teaching point TP, or to reduce a variation in the error when moving the workpiece W to the teaching point TP as compared with an aspect in which the workpiece W is moved to the teaching point TP from an arbitrary position.

### 2-5. Fifth Modification Example

In each of the above-described aspects, the workpiece movement mechanism 800 including the parallel link mechanism 850 moves the workpiece W while supporting the workpiece W, but the present disclosure is not limited thereto. The parallel link mechanism 850 includes the base member 851, the six in-link linear motion joints 801_5 to 801_10, and the output link member 854, but the shapes of the base member 851, the in-link linear motion joint 801, and the output link member 854 are arbitrary. In each of the above-described aspects, the parallel link mechanism 850 is configured to have six degrees of freedom, but for example, the parallel link mechanism 850 may be configured to have a two-degree-of-freedom mechanism that is rotatable around the Z-axis in a direction in which the mounting surface SF faces.

Further, for example, the three-dimensional object printing apparatus 100 may include a vertical articulated robot that moves the workpiece W while supporting the workpiece W instead of the workpiece movement mechanism 800. For example, the three-dimensional object printing apparatus 100 may include a six-axis vertical articulated robot. As the number of joints of the vertical articulated robot increases, a deviation of the teaching point TP increases. Therefore, the amount of positional deviation can be suitably reduced by the control method of the present embodiment.

### 2-6. Sixth Modification Example

In each of the above-described aspects, the band region BR_B and the band region BR_C include the overlapping region DR_BC and the overlapping region TR that overlap with each other, but may not include the overlapping region.

### 2-7. Seventh Modification Example

In each of the above-described aspects, the head scanning mechanism 200 may be a linear motor including a carriage that is movable in a main scanning direction, which is a direction perpendicular to the Z-axis, and a linear motion mechanism mounted on the carriage and movable in a direction along the Z-axis. The head 310 is attached to the tip end of the linear motion mechanism of the linear motor in the Z2 direction.

### 2-8. Eighth Modification Example

The application of the three-dimensional object printing apparatus of the present disclosure is not limited to printing. For example, a three-dimensional object printing apparatus that ejects a solution of a coloring material is used as a manufacturing apparatus that forms a color filter of a liquid crystal display apparatus. A three-dimensional object printing apparatus that ejects a solution of a conductive material is used as a manufacturing apparatus for forming a wiring and an electrode on a wiring substrate. The three-dimensional object printing apparatus can also be used as a jet dispenser for applying a liquid such as an adhesive to a workpiece W.

### 2-9. Ninth Modification Example

The present disclosure is applied to the three-dimensional object printing apparatus 100 including the head scanning mechanism 200 that supports the head 310 that ejects ink to the workpiece W, but the present disclosure is not limited thereto. For example, the present disclosure can also be applied to a processing device including an end effector including a drill that performs drilling on a workpiece W and a motor that rotates the drill. In addition, the present disclosure can be applied to, for example, a device for processing, painting, assembling, disassembling, or the like in which the positioning accuracy of the workpiece W is required.

### 2-10. Tenth Modification Example

The present disclosure can also be regarded as a computer program configured to cause the computer 700 or the controller 600 to execute the flowcharts described above, or a computer-readable recording medium on which the computer program is recorded. The recording medium is, for example, a non-transitory recording medium, and may include any known recording medium such as a semiconductor recording medium and a magnetic recording medium in addition to an optical recording medium such as a CD-ROM.

What is claimed is:

1. A control method for operating a robot that supports an object and includes a plurality of joints, the method comprising:
moving the object to a first teaching point after the object passes through a first point when moving the object to the first teaching point; and
moving the object to a second teaching point after the object passes through the first point when moving the object to the second teaching point.

2. The control method according to claim 1, wherein
when moving the object to the first teaching point, the object moves to the first teaching point after passing through a second point and the first point in this order, and
when moving the object to the second teaching point, the object moves to the second teaching point after passing through the second point and the first point in this order.

3. The control method according to claim 2, wherein
the robot includes L joints as a plurality of joints, L being an integer of two or more,
a number of the joints that operate when the object moves from the first point to the first teaching point among the L joints is M that is equal to or less than L, and
a number of the joints that operate when the object moves from the second point to the first point among the L joints is N that is equal to or more than M and equal to or less than L.

4. The control method according to claim 2, wherein
the robot includes L joints as a plurality of joints, L being an integer of two or more,
a number of the joints that operate when the object moves from the first teaching point to the second point among the L joints is K that is equal to or less than L, and
a number of the joints that operate when the object moves from the second point to the first point among the L joints is J that is equal to or more than K and equal to or less than L.

5. The control method according to claim 3, wherein
a number of the joints that operate when the object moves from the first teaching point to the second point among the L joints is K that is equal to or less than L, and
a number of the joints that operate when the object moves from the second point to the first point among the L joints is L.

6. The control method according to claim 1, further comprising:
correcting a movement operation in which the robot moves the object to the first teaching point based on an instruction value of the first teaching point, which is a coordinate value input when the object is moved from the first point to the first teaching point, and error information on an error between an actual position of the object when the robot moves the object to the first teaching point and the instruction value of the first teaching point.

7. The control method according to claim 6, further comprising:
correcting the movement operation based on a weight value indicating a weight of the object, the instruction value of the first teaching point, and the error information.

8. The control method according to claim 6, wherein
the error information includes first information indicating a relationship of an error between an instruction value of a first measurement point, which is a coordinate value input when a support for measurement is moved from the first point to the first measurement point, and a measurement value of the first measurement point, which is obtained by measuring an actual position of the support for measurement when the robot moves the support for measurement to the first measurement point.

9. The control method according to claim 8, wherein
the error information further includes second information indicating a relationship of an error between an instruction value of a second measurement point, which is a coordinate value input when the support for measurement is moved from the first point to the second measurement point, and a measurement value of the second measurement point, which is obtained by measuring an actual position of the support for measurement when the robot moves the support for measurement to the second measurement point, and
when a trajectory from the first point toward the first measurement point is set as a first trajectory, and when the first teaching point and the second measurement point are positioned on the first trajectory, the movement operation is corrected based on one or both of the first information and the second information, and the instruction value of the first teaching point.

10. The control method according to claim 9, wherein
when the first teaching point and the second measurement point are not positioned on the first trajectory, a measurement point close to the first teaching point is determined between the first measurement point and the second measurement point, and
when it is determined that the first measurement point is closer to the first teaching point as compared with the second measurement point, the movement operation is corrected based on the first information and the instruction value of the first teaching point.

11. The control method according to claim 8, further comprising:
generating the first information based on a measurement result of a measurement device that measures an actual position of the support for measurement when the robot moves the support for measurement to the first measurement point, and the instruction value of the first measurement point.

12. A control method for controlling a three-dimensional object printing apparatus including a robot according to claim 2 and a head scanning mechanism supporting a head that ejects liquid onto the object, the method comprising:
a first print operation in which the head scanning mechanism moves the head relative to the object while the liquid is ejected from the head onto a first region of the object in a state in which the robot stops the object at the first teaching point;
a second print operation in which the head scanning mechanism moves the head relative to the object while the liquid is ejected from the head onto a second region of the object in a state in which the robot stops the object at the second teaching point; and
a movement operation in which the robot moves the object from the first teaching point to the second teaching point between the first print operation and the second print operation such that the object passes through the second point and the first point in this order.

13. The control method according to claim 12, wherein
the first region and the second region include overlapping regions overlapping with each other.

14. A non-transitory computer-readable storage medium storing a program for causing a robot that supports an object to execute:
a process in which the object is moved to a first teaching point after the object passes through a second point and a first point in this order when moving the object to the first teaching point; and
a process in which the object is moved to a second teaching point after the object passes through the second point and the first point in this order when moving the object to the second teaching point.
